(19) United States
(12) Patent Application Publication
(10) Pub. No.: US 2008/0010178 A1
(43) Pub. Date: Jan. 10, 2008

(54) Centralized property tax management system

(75) Inventor: Denis Savard, Repentigny (CA)

Correspondence Address: MERCHANT & GOULD PC, P.O. BOX 2903, MINNEAPOLIS, MN, 55402-0903, US

(73) Assignee: CENTRALE TAXES INC./CENTRAL TAX INC., Repentigny (CA)

(21) Appl. No.: 11/700,353

(22) Filed: Jan. 31, 2007

Related U.S. Application Data
(60) Provisional application No. 60/818,520, filed on Jul. 6, 2006.

(51) Int. Cl. G06F 19/00

(52) U.S. Cl. 705/31

(57) ABSTRACT

A central system and a method for the management of property-related taxes for a plurality of properties. Each of the property-related taxes are payable to one of a plurality of taxation authorities each having an electronically accessible information system. Taxes for each of the properties are paid by at least one of a plurality of paying entities each having an electronically accessible information system. The central system includes a taxation authorities module in electronic communication with the information system of each of the taxation authorities for retrieving information on property assessments, mill rate, provincial or regional adjustments, due dates and instalments of said taxes from those. The central system also includes a processing module for producing tax-related data based on the information. The central system further includes a paying entities module in electronic communication with the information system of each of the paying entities for providing the tax-related data to those.

### CROSS-REFERENCE INFORMATION

This application is claiming priority to, and the benefit of, U.S. provisional application, Ser. No. 60/818,520, filed Jul. 6, 2006, which is hereby incorporated by reference.

### FIELD OF THE INVENTION

The present invention relates to the collection and payment of property-related taxes. More particularly, the present invention concerns a centralized system for the management of property and school taxes which provides paying entities such as financial institutions with a centralized access to taxation information gathered from taxation authorities.

### BACKGROUND OF THE INVENTION

Municipalities enjoy a certain measure of discretion in the matter of property taxes due dates. In some, taxes are payable yearly in a single installment, while in others taxes are payable in 2, 3, 4 or even 6 installments. The numerous due dates are as burdensome for the municipalities as they are for the mortgage lenders responsible for making customer taxes payments. The latter are drawn from tax reserves built up as customers gradually pay back their mortgage loans.

When it comes to property taxes, it is important to incorporate the notion of tax reserves which are common to the mortgage credit sector of the financial services industry.

The notion of tax reserves derives from residential mortgage loans insured, for example in Canada, by either Canada Housing and Mortgage Corporation (CMHC) or Genworth Financial. The purpose of mortgage insurance is to guarantee the mortgage lender reimbursement of the loan by the insurer in the event that the borrower is unable to pay back the loan to the lender.

Canada Mortgage and Housing Corporation (CMHC) and Genworth Financial, both of which ensure mortgage loans in Canada, require mortgage lenders to collect a 1/12 share of the annual property tax balance for all loans that they insure. A tax reserve is thus accumulated as the mortgage is paid back.

This obligation is included in the terms and conditions of mortgage insurance coverage. Accordingly, lenders are obligated to set up a process and take the means necessary to discharge the corresponding tax responsibility of the borrowers. Although this responsibility is directly linked to mortgage loans insured by CMHC and Genworth Financial, it is nonetheless secondary to the primary role of the lenders which is to lend and manage money.

Some institutions require mandatory borrower enrollment in a property tax reserve and payment plan. In instances such as this, borrowers have neither the choice nor the right to pay their taxes themselves, except in extremely rare circumstances.

In so requiring, institutions seek to minimize risks associated with losses incurred whenever property owners fail to pay their taxes and municipalities exercise their priority creditor rights and sell property by court order to recover taxes owing. Before reimbursing the lender, the mortgage insurer requires the lender to comply with various conditions, namely the payment of property taxes. As no allowance whatsoever is made for mortgage creditors, many of Canada's financial institutions, for example, understandably insist upon the setup of property tax reserves. In the case of regular loans, uninsured by CMHC, financial institutions have no choice but to rely upon borrowers and the provisions of their mortgage guarantees to recover loans.

Nearly all tax payment transactions are conducted manually. Financial institutions must first obtain the taxation information for a given property, and usually depend on the customer to provide them with this information by forwarding his taxation statements. This process is unreliable as customers often forget to forward the information. The financial institutions then have to debit tax accounts and prepare bank drafts made out to the order of municipalities, school boards, etc. The bank drafts are then mailed to the entities concerned. These manual operations are as tedious as they are time consuming.

As lenders conduct business with, for example, over 4400 municipal administrations across Canada, three quarters of which having a population of less than 5000 inhabitants, one can readily imagine just how complex and costly the development of a platform for the computerized management of transactions with such a large number of municipalities would be for a single mortgage lender.

Among the prior art, there is patent application US 2003/0018575 A1 which describes a method and apparatus for facilitating communication and payments for and among borrowers and investors regarding commercial mortgage backed securities and related properties and commercial mortgage loan accounts. This system is provided via at least one commercial mortgage backed security. It allows access by a borrower to an electronically accessible resource including information regarding a commercial mortgage loan account; determine a payment due from the borrower within a time period, it provides a notification to the borrower regarding the payment; receives authorization and processes the payment.

Patent application US 2004/0078271 A1 describes a system and method for tax reporting of taxable and non-taxable distributions, gains and losses of investments including providing access to tax information regarding the investments and providing various functions pertaining to the tax information. The system and method can be used by financial institution personnel to view and adjust tax information on tax forms. It can also be used to perform tax reporting.

Patent application US 2002/0174017 A1 describes a method and a system where property tax data may be mined from existing asset databases. These databases commonly do not communicate with other databases since they are developed for specialized purposes. By mining tax sensitive data from the databases, tax management software may develop information for property tax compliance or tax planning purposes. For example, information about property tax exemptions and possible exclusions may be mined from the data together with information about the assets' location which may be important to allocating assets to particular tax jurisdictions.

None of the systems described previously provide automation for the collection of property-related taxes information for a plurality of properties from a plurality of taxation authorities, thus allowing a more efficient management and the elimination of tedious manual operations.

The present invention overcomes several disadvantages of the prior art, mainly the tedious and time consuming manual operations, as will be discussed in detail below.

### OBJECTS AND SUMMARY OF THE INVENTION

It is an object of the present invention to provide a scheme allowing easy and convenient access to tax-related information from a plurality of different taxation authorities.

It is a secondary object of the invention to facilitate the provision and management of tax reserves for property owners.

In accordance with one aspect of the present invention, there is provided a central system for the management of property-related taxes for a plurality of properties, each of these property-related taxes being payable to one of a plurality of taxation authorities. Each taxation authorities has an electronically accessible information system. Taxes for each of the properties are paid by at least one of a plurality of paying entities, each having an electronically accessible information system.

The central system first includes a taxation authorities module in electronic communication with the information system of each of the taxation authorities for retrieving information relative to due dates and instalments of the taxes therefrom. A processing module is also provided for producing tax-related data based on this information. The central system also includes a paying entities module, in electronic communication with the information system of each of the paying entities, for providing the tax-related data thereto.

In accordance with another aspect of the present invention, there is also provided a method for the management of property-related taxes for a plurality of properties, using a central system. Each of the property-related taxes is payable to one of a plurality of taxation authorities each having an electronically accessible information system. Taxes for each of the properties are paid by at least one of a plurality of paying entities each having an electronically accessible information system. The method includes the following steps of:
a) retrieving information relative to due dates and instalments of the taxes from the taxation authorities, the central system including a taxation authorities module in electronic communication with the information system of each of the taxation authorities therefor;
b) producing tax-related data based on the information, the central system comprising a processing module therefor; and
c) providing the tax-related data to the paying entities, the central system comprising a paying entities module in electronic communication with the information system of each of the paying entities therefor.

In accordance with yet another aspect of the present invention, there is provided a method for the automated estimation of taxes payable for a property of interest, using a central system for the management of property-related taxes for a plurality of properties, each of said property-related taxes being payable to one of a plurality of taxation authorities each having an electronically accessible information system, taxes for each of said properties being paid by at least one of a plurality of paying entities each having an electronically accessible information system, said method comprising the steps of:
a) retrieving information on the taxes payable for said property of interest from at least one corresponding one of said taxation authorities, said central system comprising a taxation authorities module in electronic communication with the information system of each of said taxation authorities therefor;
b) producing estimation based on said information, said central system comprising a processing module therefor; and
c) reporting said estimation.

Embodiments of this last aspect of the invention can for example be particularly useful for mortgage lenders wishing to take into consideration the taxes to be paid for a given property in their evaluation of a mortgage application.

The objects, advantages and other features of the present invention will become more apparent upon reading of the following non-restrictive description of preferred embodiments thereof, given for purpose of exemplification only, with reference to the accompanying drawings.

### BRIEF DESCRIPTION OF THE DRAWINGS

FIG. 1 is a schematic view of the central system of the preferred embodiment of the invention showing the central system and its environment.

FIG. 2 is a detailed view of the central system of FIG. 1.

FIG. 3 is a block diagram of the central system of FIG. 1.

FIG. 4 is a flowchart of the method of the preferred embodiment of the invention.

FIG. 5 is a flowchart showing detailed steps of the step of retrieving information of FIG. 4.

FIG. 6 is a flowchart showing detailed steps of the step of producing tax-related data of FIG. 4.

FIG. 7 is a flowchart showing detailed steps of the step of providing tax-related data of FIG. 4.

FIG. 8 is a flowchart of the method according to another embodiment of the invention.

FIG. 9 is a snapshot of the creation of a tax reserve screen of the user interface according to the preferred embodiment of the invention.

FIG. 10a is a snapshot of the tax management screen of the user interface according to the preferred embodiment of the invention, showing tax-related data on the tax reserve.

FIG. 10b is a snapshot of the tax management screen of the user interface of FIG. 10a, showing the tax-related data of the tax reserve edited.

FIG. 11 is a snapshot of the tax management screen of the user interface of FIG. 10a, showing tax-related data on the property.

FIG. 11a is a snapshot of the tax management screen of the user interface of FIG. 10a, showing the tax-related data of the property edited.

FIGS. 11b and 11c are snapshots of the tax management screen of the user interface of FIG. 10a, showing tax-related data on the owner.

FIGS. 12 to 68 are screen shots of different screen according to another embodiment of the present invention.

While the invention will be described in conjunction with an example embodiment, it will be understood that it is not intended to limit the scope of the invention to such embodiment. On the contrary, it is intended to cover all alternatives, modifications and equivalents as may be included.

### DESCRIPTION OF PREFERRED EMBODIMENTS

In the following description, similar features in the drawings have been given similar reference numerals and in order to weight down the figures, some elements are not referred to in some figures if they were already identified in a precedent figure.

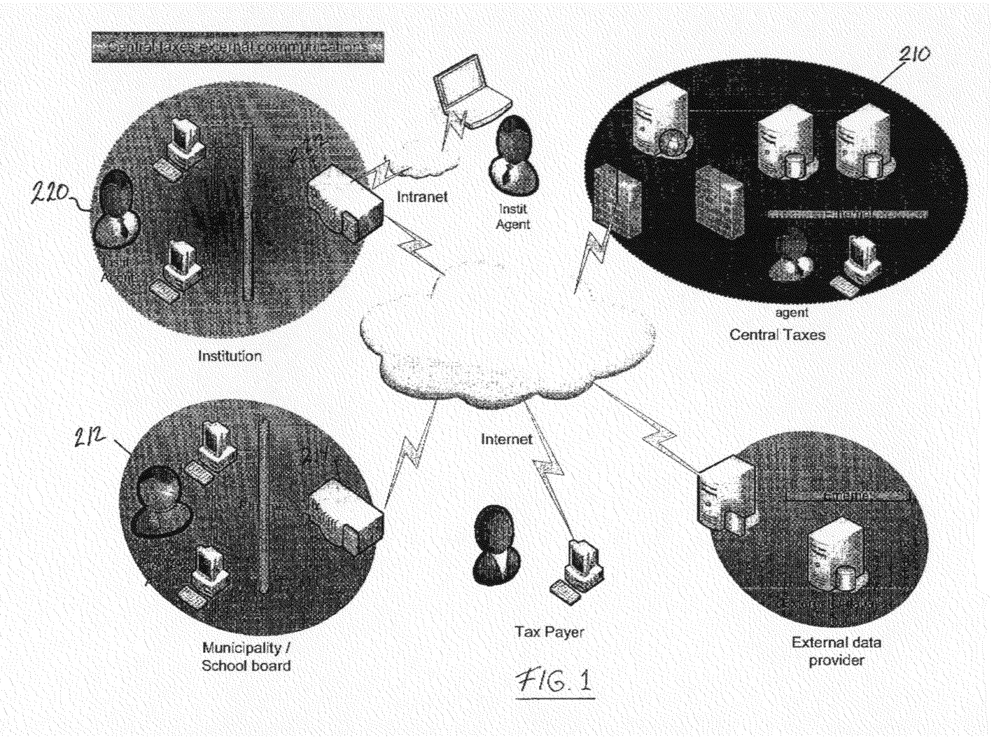

Shown in FIGS. 1 to 3, the central system 210 of the present invention is for the management of property-related taxes for a plurality of properties. The term “properties” is meant to include any kind of real estate such as houses, condominiums, apartment buildings, commercial buildings, industrial buildings, public buildings, pieces of land, etc. “Property-related taxes” are therefore understood to refer to any tax which may be imposed on the owner of a such properties. The property related taxes may be periodical, such as annual payments to municipalities and school boards, or punctual, as for a real property transfer tax. Each of the property-related taxes is payable to one of a plurality of taxation authorities 212 each having an electronically accessible information system 214. The term “taxation authorities” may refer to municipalities, agglomerations, school boards, province, state, country, or any other authority which may impose a tax or taxes on a property. As will be readily understood by one skilled in the art, the central system of the present invention may manage property-related taxes payable to taxation authorities of different types. The taxes for each of the properties are paid by at least one of a plurality of paying entities 220 each having an electronically accessible information system 222. The term “paying entities” is meant to include any entity likely to make such payments, such as the central system of the present invention, financial institutions, banks, property owners, mortgage lender, credit unions etc.

As mentioned above, the collection and payment of property taxes by financial institutions requires that these paying entities complete a multitude of forms and documents and preferably build a tax reserve in order to make allowance for numerous due dates. These operations are complex and costly when conducted manually. The central system of the present invention undertakes to automate and centralize clerical activities and may advantageously encourage borrowers as well as lenders to set up tax reserves. In its preferred embodiments, the system of the present invention therefore proposes a more efficient means of managing the different steps involved in the complex process of building tax reserves and paying the installments before each due date.

The present invention provides a central system preferably accessible either via a network, like the Web for example, in application service provider (ASP) mode or by means of complete integration into existing systems.

The central systems enhances, standardizes, automates and reduces the manual processing of tax payments which is complex owing to the abundance of towns, cities and school boards and an equal abundance of tax payment due dates. Payment of municipal and school taxes becomes facilitated and the centralized access to taxation information further opens the door to a number of new and lucrative banking solutions and services.

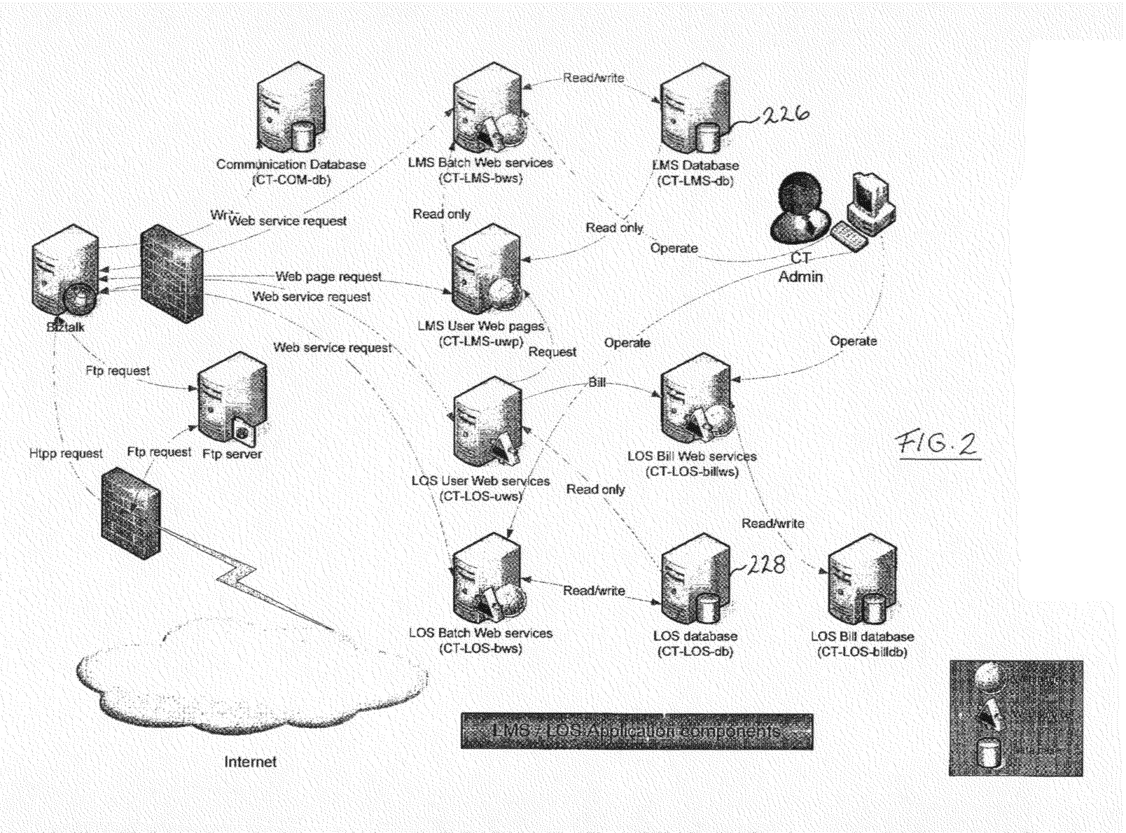

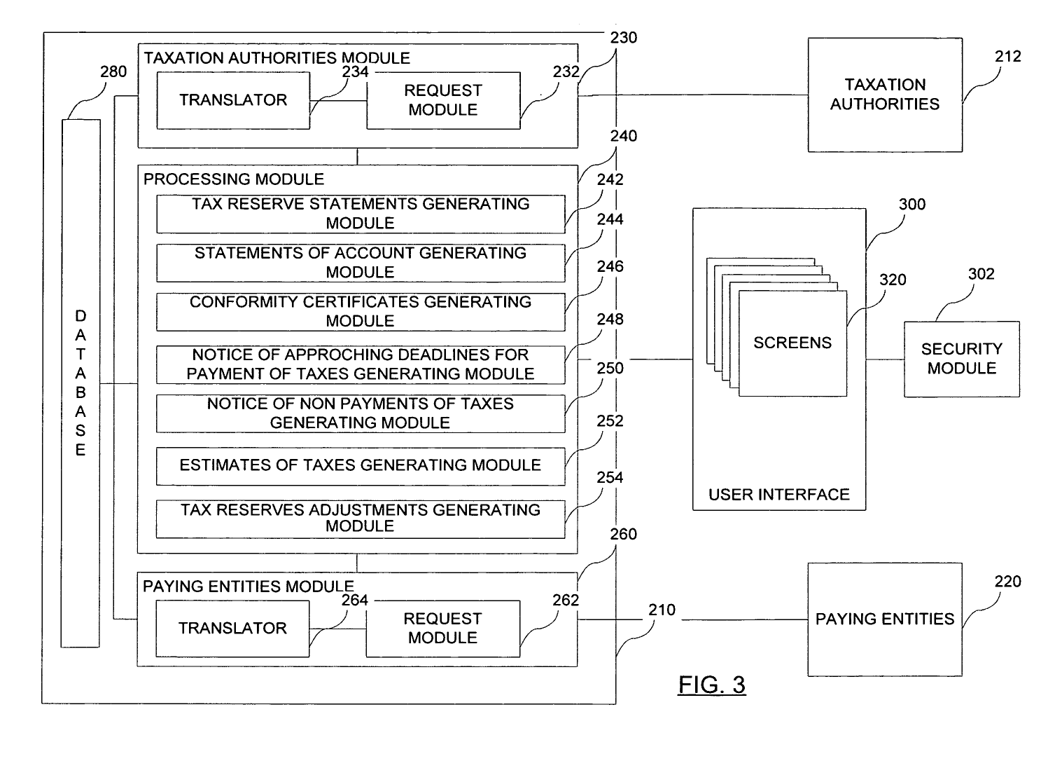

Referring to FIGS. 1 and 3, the central system 210 of the present invention first includes a taxation authorities module 230 in electronic communication with the information system 214 of various taxation authorities 212 for retrieving information relative to due dates and instalments of the taxes from the taxation authorities. Typically, the information system 214 of a given taxation authority will be embodied by a local network accessible internally through several workstations, and include a server connected to the internet allowing outside access. The electronic communication between the taxation authorities module 230 of the central system 210 is therefore preferably made through the internet and the central system, as better shown in FIG. 2, is preferably provided with one or more servers and appropriate security systems. The central system may also include a Loan Management System (LMS) database 226 as well as a Loan Origination System (LOS) database 228.

The information relative to due dates and instalments of the taxes can be embodied by any data allowing determining what amounts of taxes are due for a given property and when. Dates and amounts may be obtained directly or indirectly. In practice, this information may for example include the property assessment for a given property, which can be used in combination with the mill factor for the corresponding taxation authorities to calculate the instalments. The mill factor, or taxation rate, is often constant over a given one-year period and may be stored in the central system 210. Alternatively, the mill factor may be part of the information obtained electronically from the taxation authorities.

As the information system 214 of the taxation authorities can vary greatly from one taxation authority to the next, the taxation authorities module is preferably compatible with a broad range of database types, including those powered by Oracle®, as well as various operating systems and programming languages such as those developed by IBM®. The taxation authorities module 230 preferably includes a requests module 232 for sending requests to the information systems of the taxation authorities to obtain the due dates and instalments. The taxation authorities module also includes a translator 234 for converting the requests into a format readable by the information system of the taxation authorities to which the request is sent. The translator 234 is also for converting the information relative to due dates and instalments received from the information systems from the corresponding format into a central system format readable by the central system. The translator may for example be embodied by a XML translator which enables the taxation authorities module to be compatible with an impressive quantity of languages and systems, including many developed internally by larger municipalities.

The central system can also include the information system of at least one of the taxation authorities itself. This means that at least the database or all the information system of the taxation authority is hosted by the central system. The information system of the taxation authorities preferably contains the information relative to due dates and instalments such as property assessments, the calendar of due dates, etc. The access to the information system of the taxation authorities, when hosted by the central system, is accelerated since the communications do not have to go through the internet or through another external network.

The central system 210 also includes a processing module 240 for producing tax-related data based on the information retrieved from the taxation authorities 212. The tax-related data produced by the processing module includes, for at least one of said properties, at least one of the due dates, the instalments, an annual taxes adjustment, a total amount of unpaid taxes for a predetermined time period, a total amount of paid taxes for a predetermined time period, and an amount of taxes over due.

The tax-related data can also include tax reserve statements, statements of account, conformity certificates, notices of approaching deadlines for payment of taxes, notices of non payments of taxes, property taxes estimate for a brand new building, as well as notices for the annual tax reserve adjustment upon timely property tax increase.

It should be understood that the tax-related data can also comprise any data retrieved from a banking system or calculated from these data.

The central system includes a database 280 for storing the tax-related data. For security reasons, the database can be hosted by the paying entities. The central system thus access the database through a network, processes the data, produces tax-related data and stores the tax-related data in the database hosted by the paying entities. In another embodiment, the central system could be hosted by the paying entities and the processing of data and producing of tax-related data could be done locally at the paying entities.

The tax-related data may feature a single electronic statement of account which details accumulated property tax reserves and property tax payments made. This electronic statement of account is preferably customer accessible by secure Internet connection twenty four hours a day, seven days a week.

The central system may also provide paying entities with a yearly report on property tax payments made by their mortgage clients. Any relevant information can be provided on this report. Alternatively, the taxation authorities may provide a list of their tax payers or properties for which tax payments are overdue. In both cases, the financial institution can become aware of potential problems with particular clients and act accordingly.

Furthermore, with the central system of the present invention, customers or tax payers can monitor their transactions regarding the payment of taxes, because they have an access to tax-related data produced by the central system, which was not the case in prior art.

In order to produce some of these tax-related data, the processing module 240 comprises at least the following modules: a tax reserve statements generating module 242, a statements of account generating module 244, a conformity certificates generating module 246, a notices of approaching deadlines for payment of taxes generating module 248, a notice of non payments of taxes generating module 250, an annual tax reserve adjustment generating module, a property taxes estimation generating module 252 and a tax reserves adjustments generating module 254 for annual adjustments of the tax reserves. As apparent to a person skilled in the art, many other modules could be added in order to produce different reports, statements or data as customary in the banking business.

Furthermore, the present invention provides electronic alternatives for traditional tax management operations, which generally include six main components that can be automated. They are the calculation of payable taxes, the collection of tax portions to build a tax reserve, the tax payments, the follow up on overdue tax accounts, the forwarding of notices and the issue of drafts and the debiting of reserve. Preferably, the preferred embodiment of the invention comprises a module for executing each of these.

In addition, electronic funds transfer (EFT) functions, programmable payment functions, pre-authorized and Web based debit functions, as well as tax financing and overdraft protection could be available with the central system. The system preferably allows the setup of an electronic deposit account with the selected Creation trust, the object being to avoid unnecessary movements of funds between paying entities and taxation authorities. Payments made electronically, eliminate cheques and cheque handling delays and any due date changes can be forwarded directly to customers by the central system via secure e-mail or even regular post.

Furthermore, the central system allows to regroup several mortgages for different properties such as townhouse, secondary residence, property investments, under a single customer name, even if the property are located in different municipalities. The accumulation of a tax reserve becomes possible for residential property owners living in apartment buildings, for commercial and industrial property owners and even for foreign property owners.

Advanced modules can also be added to the system of the present invention. These modules and corresponding tax-related data are for managing the money accumulated in tax reserves but not due in a short delay. Financial institutions can effectively profit from this money and invest it, to make it fructify, until the moment it is due to the taxation authorities.

The central system 210 also includes a paying entities module 260 in electronic communication with the information system of each of the paying entities 220 for providing the tax-related data to the paying entities. Typically, the information system 222 of a given paying entity will be embodied by a local network accessible internally through several workstations, and include a server connected to the internet allowing outside access. The electronic communication between the paying entities module 260 of the central system 210 is therefore preferably made through the internet or a secure network and the central system is preferably provided with one or more servers and appropriate security systems.

As the information system 222 of the paying entities can vary from one paying entity to the next, the paying entities module is preferably compatible with a broad range of database types, including those powered by Oracle®, as well as various operating systems and programming languages such as those developed by IBM®. The paying entities module preferably includes a requests module 262 for receiving requests from the information system of the paying entities and for sending the tax-related data to the paying entities. The paying entities module also includes a translator 264, for converting the requests into a central system format readable by the central system, and for converting the tax-related data into a format readable by the information system of at least one of the paying entities from which the requests are received. The translator may for example be embodied by a XML translator which enables the paying entities module to be compatible with an impressive quantity of languages and systems, including many developed internally by financial institutions.

The central system entrusts third parties with deposits or trusts and financial institutions with the financing of tax reserves. Banks and credit unions are therefore very much present in matters of transaction generation and management.

The central system can therefore be considered as a supplier or privileged supplier of financial institutions invested with the task of conducting back office activities which, to all intents and purposes, are not central to the core activities of these financial institutions.

As for tax payers, the central system represents an additional service made available to them by their financial institutions in the form of a one-stop portal service facility bearing the logo and livery of the individual financial institution. The overall aim of this additional service is to ensure that tax-related activities are processed in the most efficient manner possible.

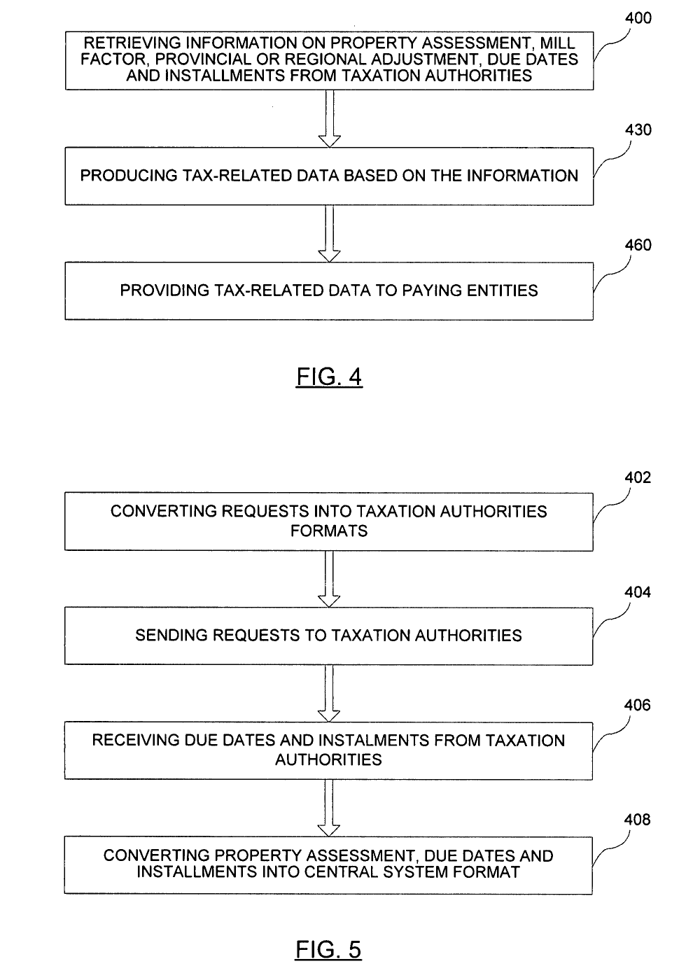

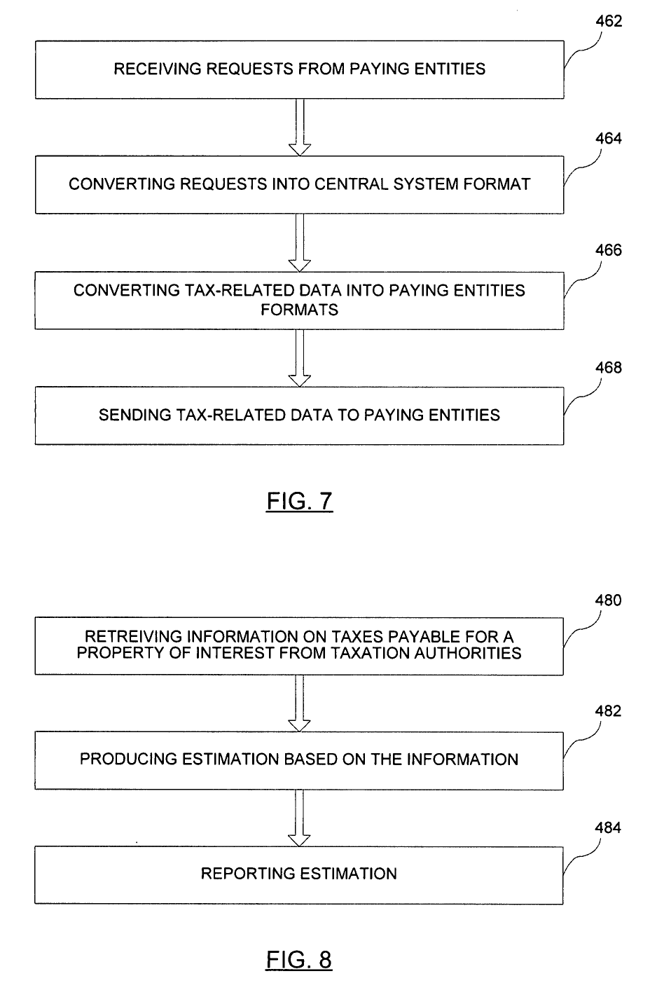

Now referring to FIGS. 4 and 8, according to another aspect of the invention there is a method for the management of property-related taxes for a plurality of properties, using the central system 210. Each of the property-related taxes are payable to one of a plurality of taxation authorities 212 each having an electronically accessible information system 214. The taxes for each of the properties are paid by at least one of a plurality of paying entities 220 each having an electronically accessible information system 222.

The method includes a step of retrieving information relative to due dates and instalments 400 of the taxes, the central system having a taxation authorities module 230, in electronic communication with the information system 214 of each of the taxation authorities 212, for this purpose. In addition to actual due dates and instalments, the retrieved information may be embodied by property assessments, mill factors, provincial or regional adjustments, etc. The method also includes a step of producing tax-related data 430 based on the information retrieved, the central system also having a processing module 240 for this purpose. The method includes another step of providing the tax-related data to paying entities 460, the central system having a paying entities module 260 in electronic communication with the information system 222 of each paying entities 220 for this purpose.

The method also preferably includes the step of sending requests to the information systems of the taxation authorities 404 to obtain the due dates and instalments 406 from those. The taxation authorities module has a requests module 232 for this purpose. The method also preferably includes the steps of converting the requests into a format readable by the information system 402 of the taxation authorities to which the request is sent, and of converting the due dates, property assessments or instalments 408 received from the information systems from the corresponding format into a central system format readable by the central system. The taxation authorities module preferably has a translator 234 for this purpose.

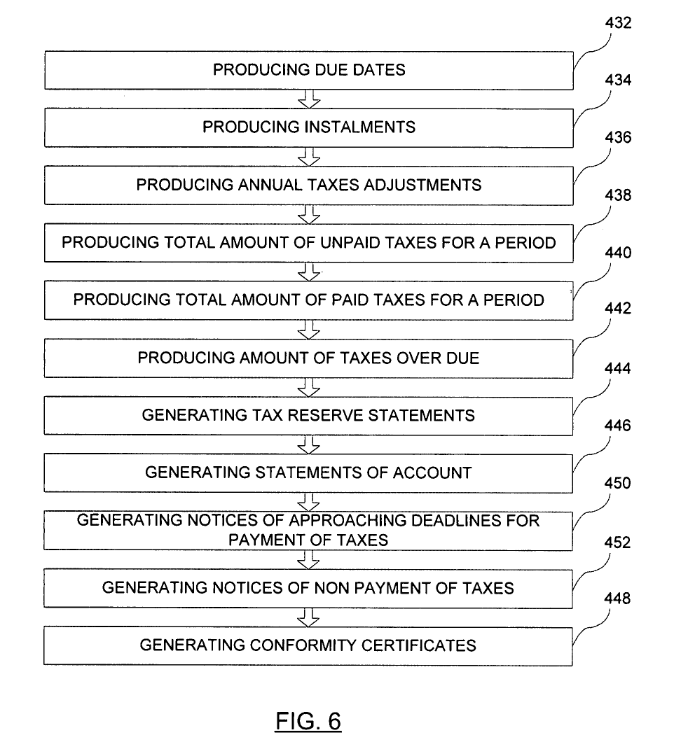

Referring to FIG. 6, the tax-related data produced based on the information retrieved from the taxation authorities 212 preferably includes, for at least one of said properties, at least one of the due dates 432, the instalments 434, an annual taxes adjustment 436, a total amount of unpaid taxes for a predetermined time period 438, a total amount of paid taxes for a predetermined time period 440, and an amount of taxes over due 442.

The method may also includes the steps of generating tax reserve statements 444, generating statements of account 446, generating conformity certificates 448, generating notices of approaching deadlines for payment of taxes 450, generating notices of non payment of taxes 452 and generating assessments of taxes 454, for the properties. As apparent to a person skilled in the art, many other steps could be added in order to produce different reports, statements or data as customary in the banking business.

The method may also include the steps of receiving requests 462 from the information system 222 of the paying entities 220 and of sending the tax-related data 468 to the paying entities 220, the central system 210 having a paying entities module 260 for that purpose.

Preferably, the method includes the step of converting the requests 464 into a central system format readable by the central system. The paying entities module 260 comprises a requests module 262 for this purpose. The method also comprises the step of converting the tax-related data 466 into a format readable by the information system 222 of at least one of the paying entities 220 from which the requests are converted. The paying entities module has a translator 264 for this purpose.

According to another aspect of the invention there is provided a method for the automated estimation of taxes payable for a property of interest, using the central system 210. The method generally includes the steps of retrieving information 480 on taxes payable for the property of interest, producing an estimation 482 based on this information and reporting this estimation 484.

The central system can also be used to estimate an initial amount to be put into the tax reserve in order to be able to meet the due dates with enough money to pay the due amounts.

Since property taxes such as municipal and school taxes are important expenses associated with ownership of a home, these expenses could easily increase a prospective owner's financial burden above his limit, especially for borderline cases. Mortgage lenders now can take this factor into consideration when evaluating an application thanks to the central system of the present invention.

Furthermore, as it can be very advantageous for financial institutions to be aware whether or not property taxes for a property have been duly paid before granting a mortgage, the tax-related data and the statements produced by the central system can facilitate the identification of potential risk factors. The present invention provides mortgage lenders with a tool which allows them to include the cost of property-related taxes in the evaluation of a mortgage application. Through the connection to taxation authorities, the central system of the present invention allows mortgage lender to take into account the precise amount of the taxes required for a given property in order to calculate the total debt ratio (TDR) of the borrower. This evaluation can also include property transfer taxes.

In one embodiment, a module may be provided to estimate the taxes which will be required for a new property based on taxation rates associated with the corresponding municipality based on the borrowed amount for the construction. Preferably, the central system allows mortgage lenders to run simulations in order to obtain the necessary information. In a preferred embodiment, the simulation may be incorporated into the financial institution's own application evaluation or adjudication system for an even more transparent integration to existing processes.

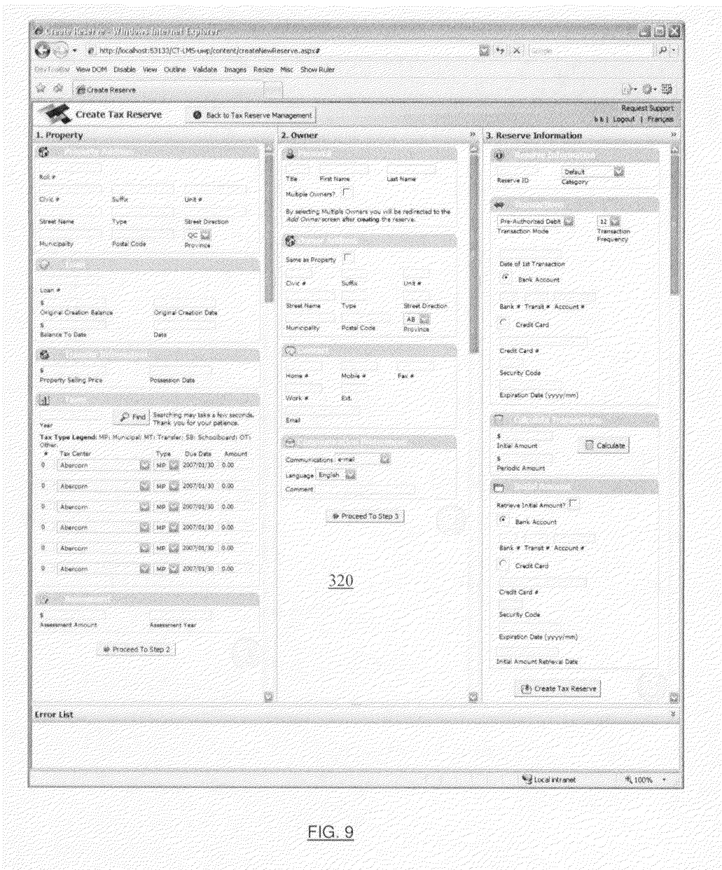

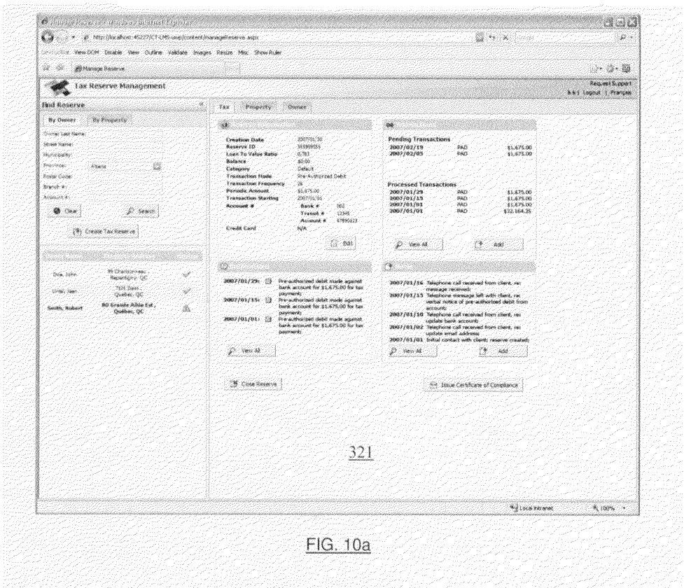

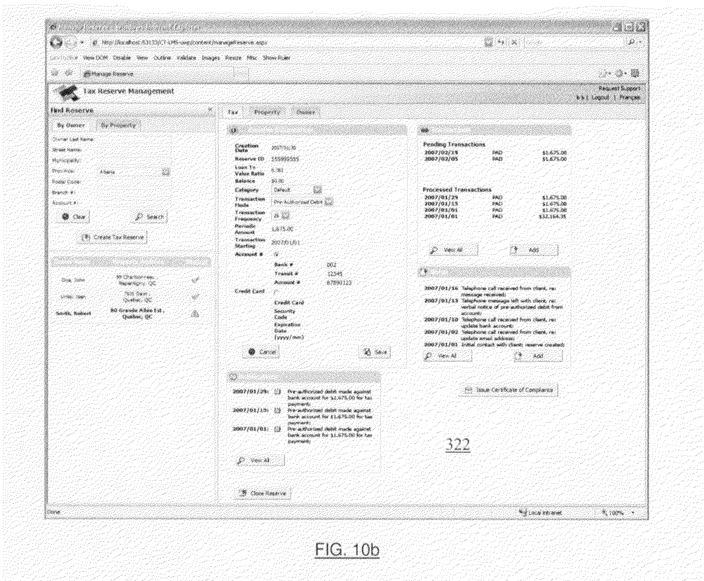

Referring to FIGS. 9 to 11, the central system of the present invention includes a user interface 300 accessible via a network. Since the central system can be hosted by the paying entities, or can be hosted in a remote location, the user interface can be displayed through the internet, for example. Thus, security means must be in place to prevent third party from having access to the data displayed. The user interface can be displayed to people working for paying entities and taxation authorities through the internet, as well as to tax payers. The user interface can be customized with the logos, colors, fonts, etc. of the paying entities.

To ensure that communications are consistent with the expectations of all parties, the system preferably provides secure access seven days a week, twenty four hours a day. This feature is advantageous as it enables financial institutions to check a given customer account or group of accounts quickly, easily and under optimal conditions.

Still referring to FIGS. 9 to 11, the user interface has screens 320, 321, 322, 323, 324, 325 and 326 having links with the processing module 240 of the central system. Thus, it is possible to actuate different processing of tax-related data from different user interface screens. Screen 320 is used to create a tax reserve. Tax-related data on the property, the owner and the tax reserve can be entered through screen 320 upon creation of a tax reserve.

After the tax reserve has been created, it is possible to manage its tax-related data through the tax management screen. The tax reserve, the property and the owner tax-related data can be viewed through screens 321, 323 and 325. It is also possible to edit the tax reserve, the property or the owner tax-related data through screens 322, 324 and 326.

Through the user interface, data can be entered, processing can be initiated, reports, charts, graphics and the like can be displayed, as will be described in more details in the next section.

The user interface further comprises a security module 302, shown in FIG. 3, for verifying a username and a password entered by the user. The username and password are associated with a profile limiting the access of the user to selected of the screens. Thus, a tax payer has access to a limited number of screens and cannot have access to tax-related data pertaining to another tax payer or to a paying entity. The same principle applies to any other group of users, as usual in the banking business.

The central systems of the preferred embodiment have been developed using proven technology and software provided by Microsoft®.

Furthermore, the central system should ensure complete compliance with all applicable legislation governing the financial and municipal services industry, which is very variable among different municipalities and countries.

Moreover, the system preferably complies with all legislation respecting the confidentiality of personal data, and maintains and regularly updates relevant legal opinions, the majority of which are obtained from senior counsel. In the matter of customer databases, the system preferably provides data confidentiality. All appropriate means of monitoring and protecting personal data and information, as provided for under applicable legislation, can be used.

Transactions involving the setup of property tax reserves confer upon the system the role of specialized intermediary. Additionally, the property tax financing aspect of company operations confers upon the system the role of referral agent.

### Demonstration Software

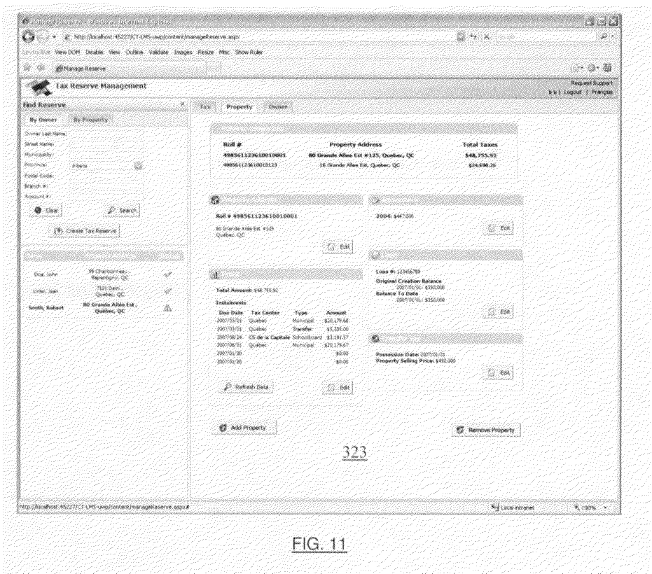

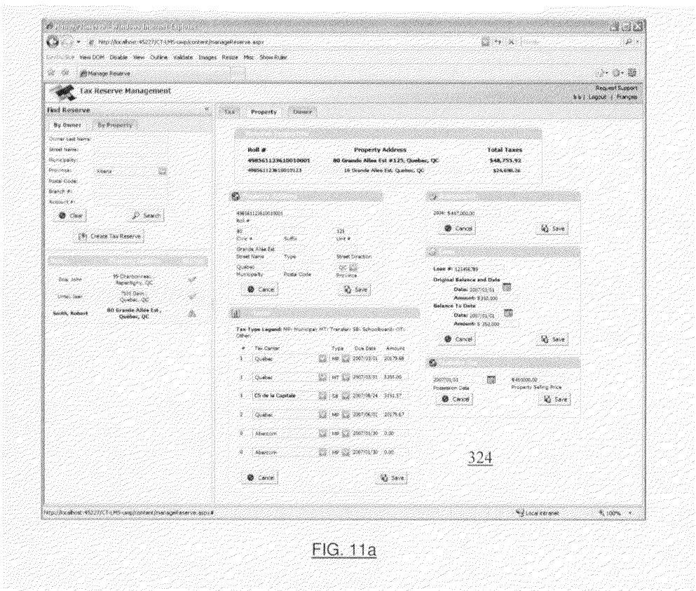

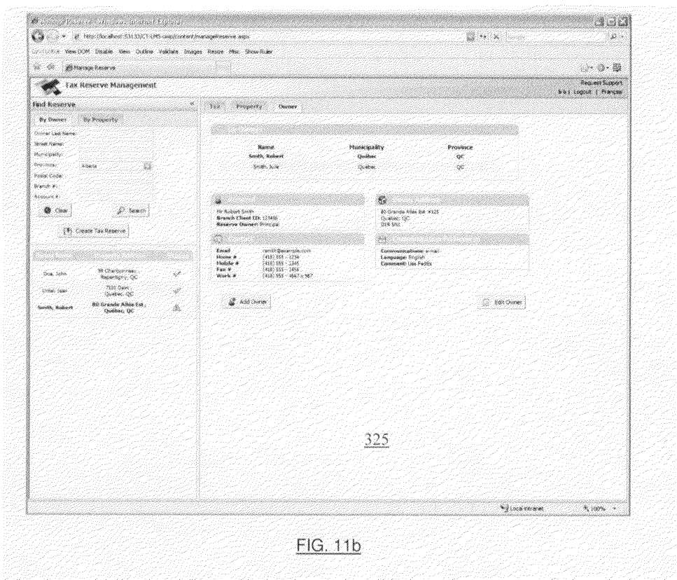

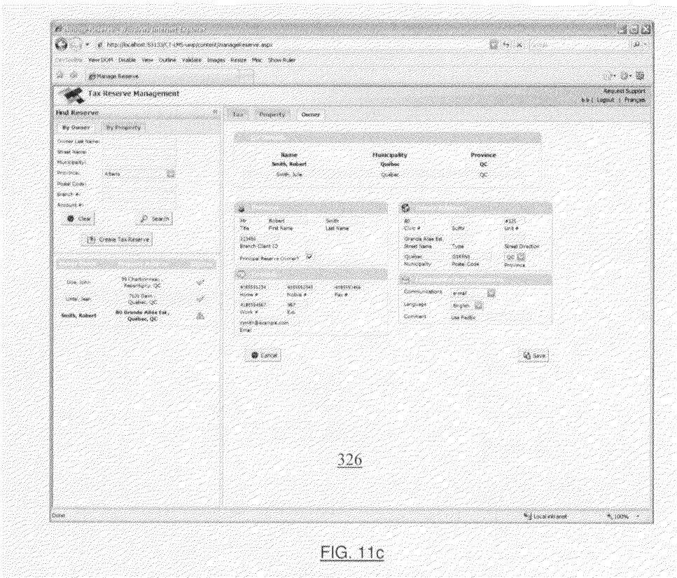

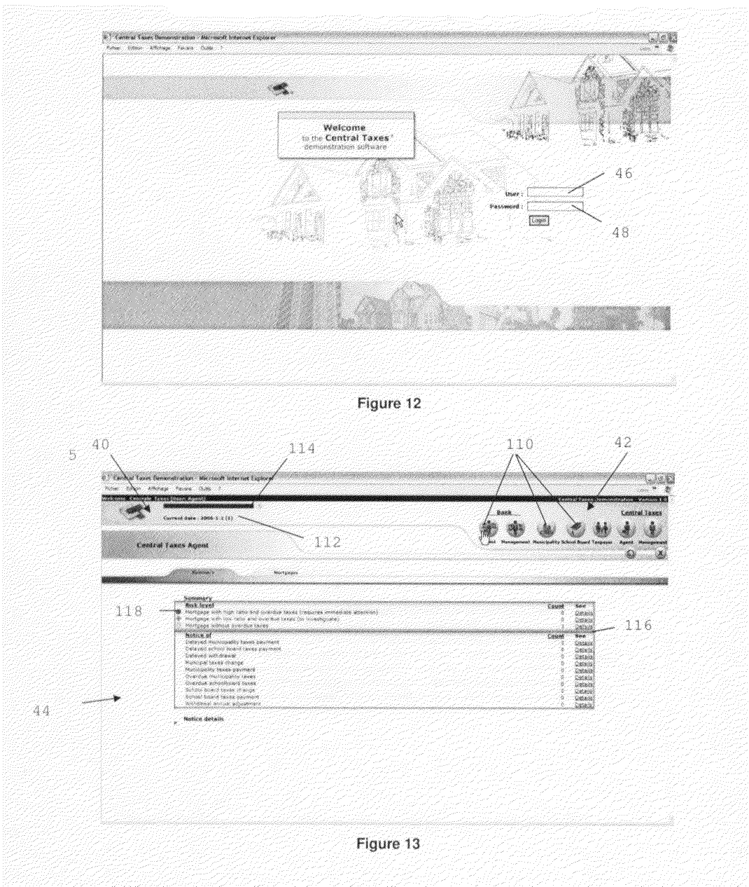

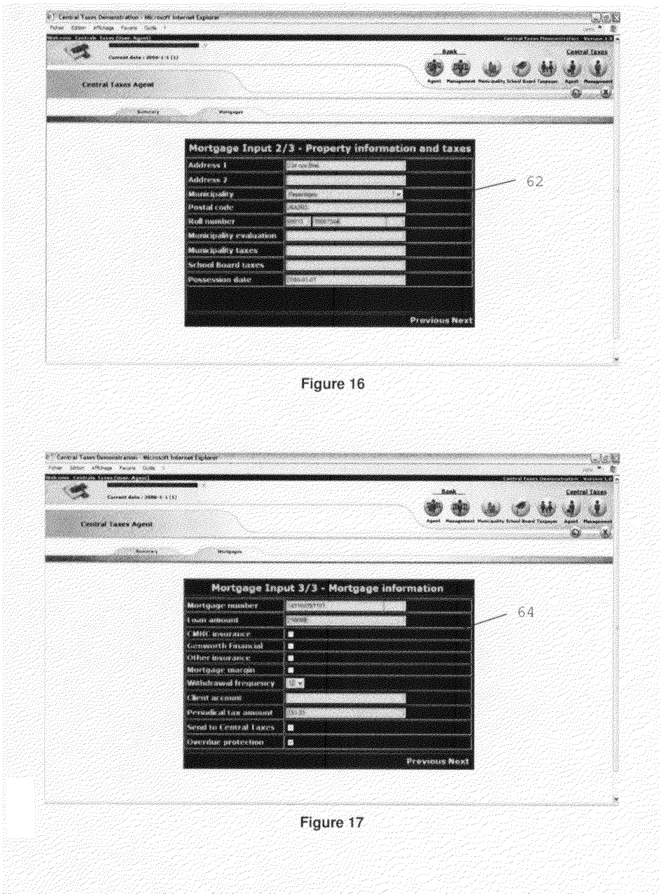

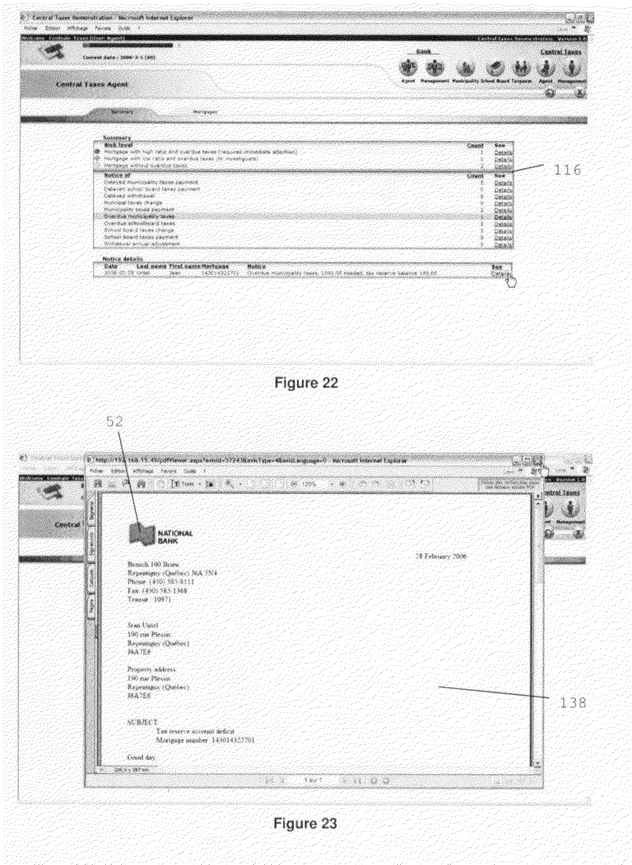

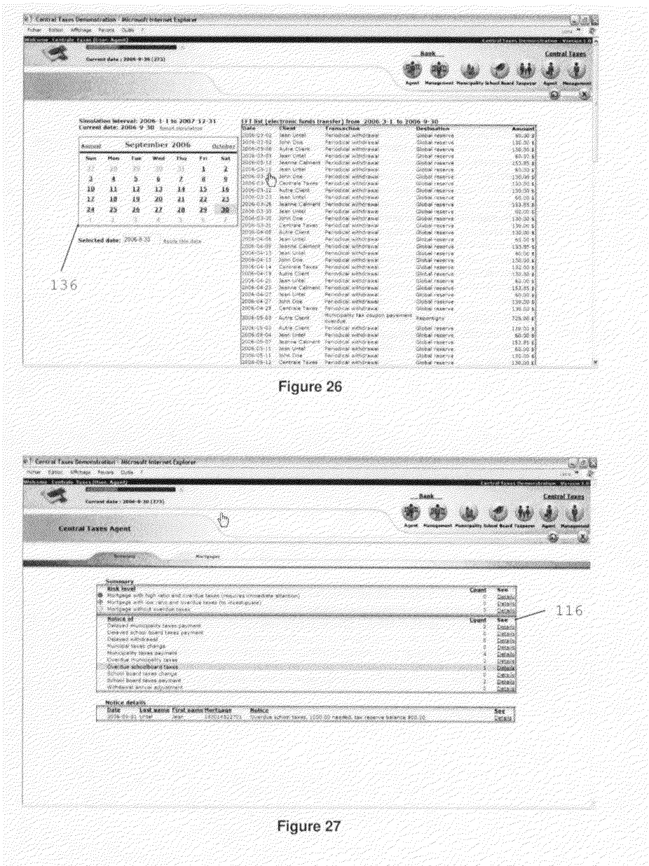

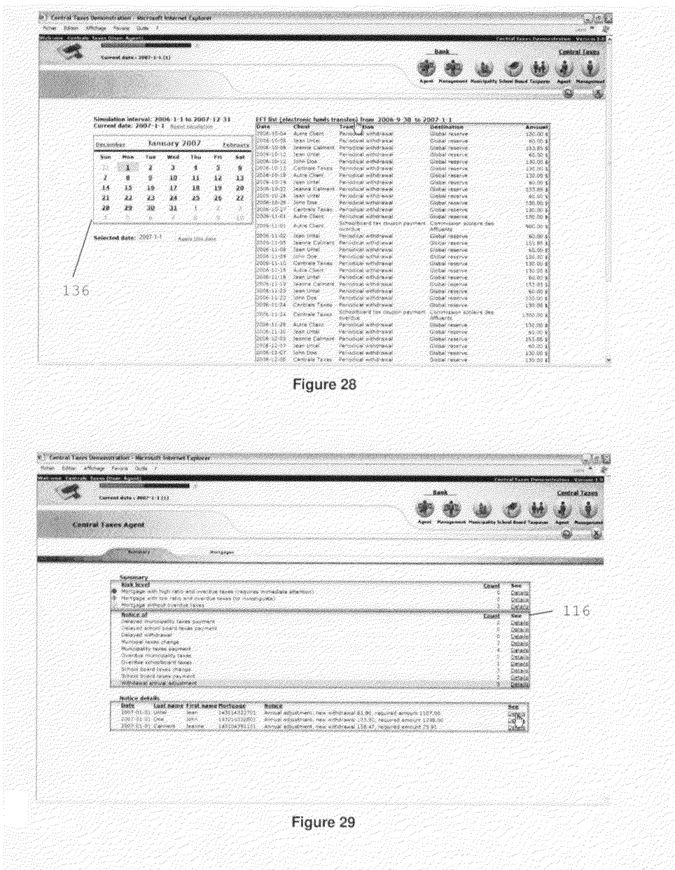

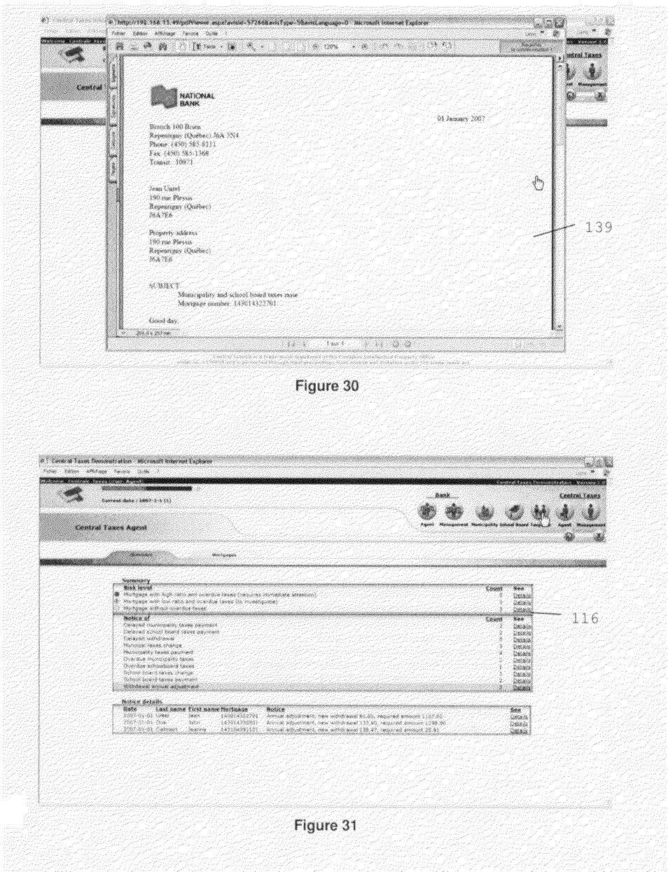

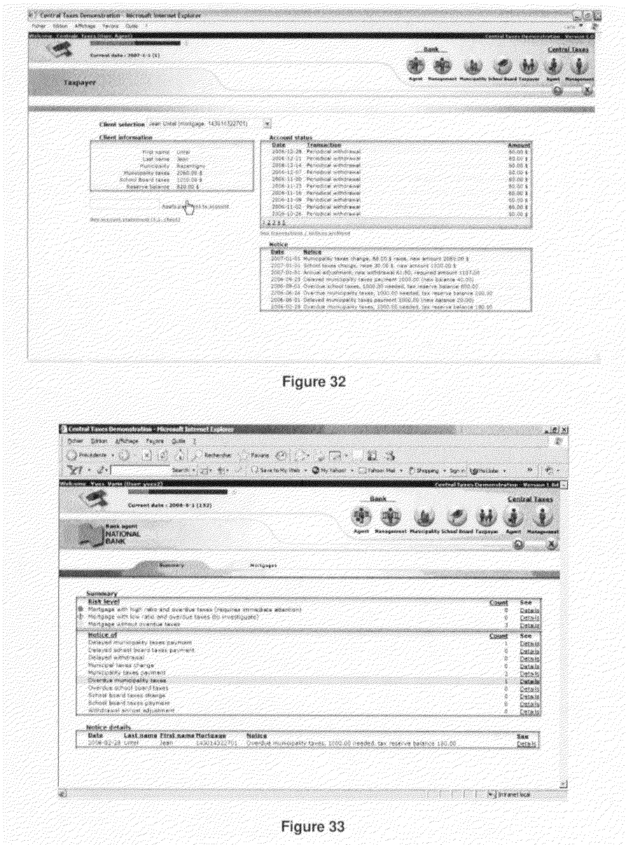

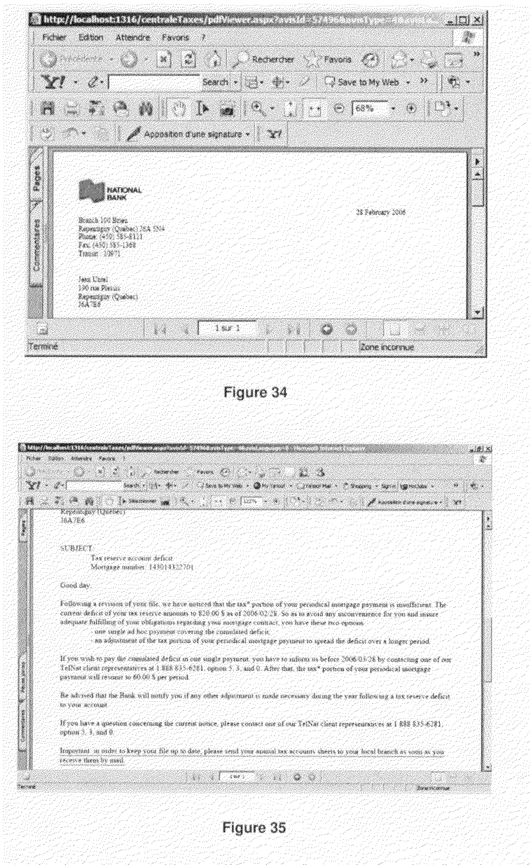

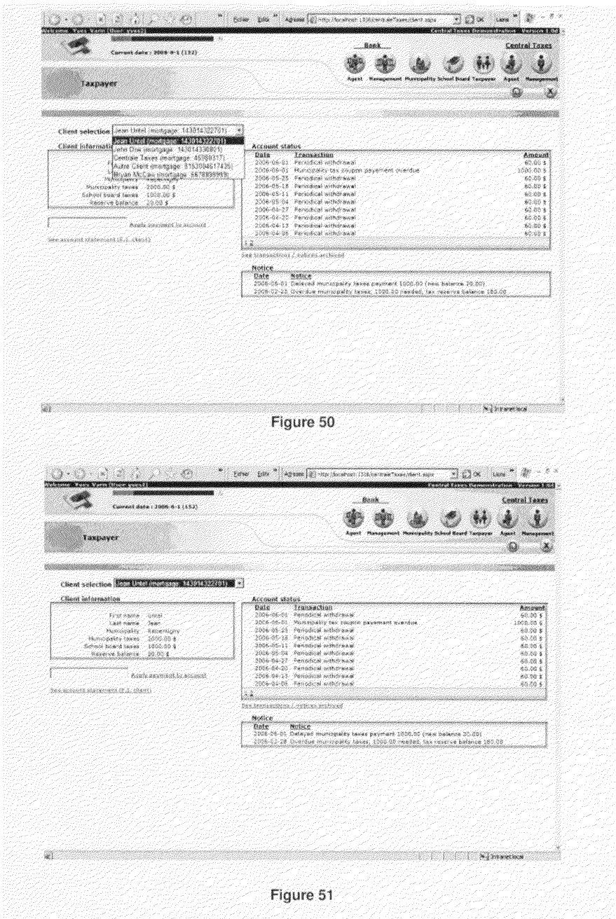

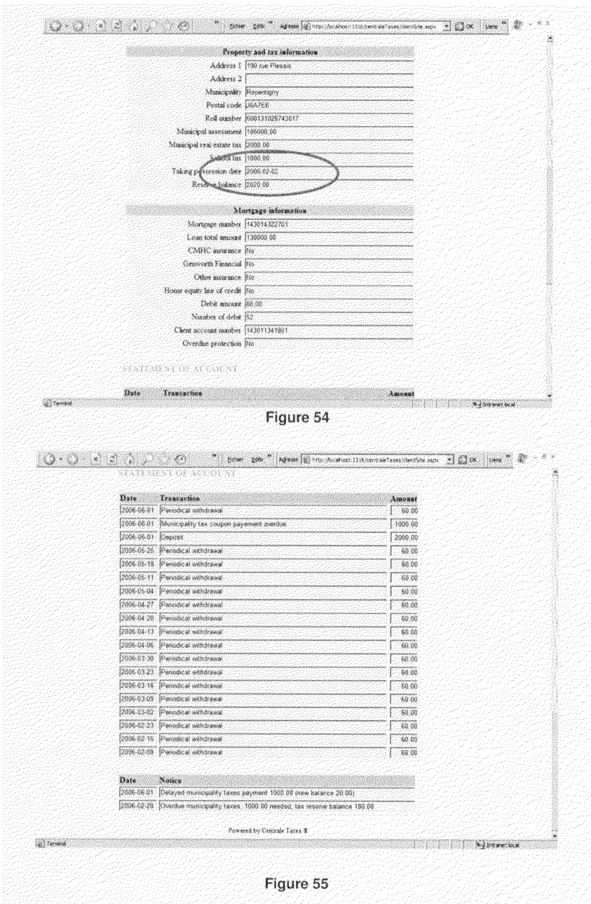

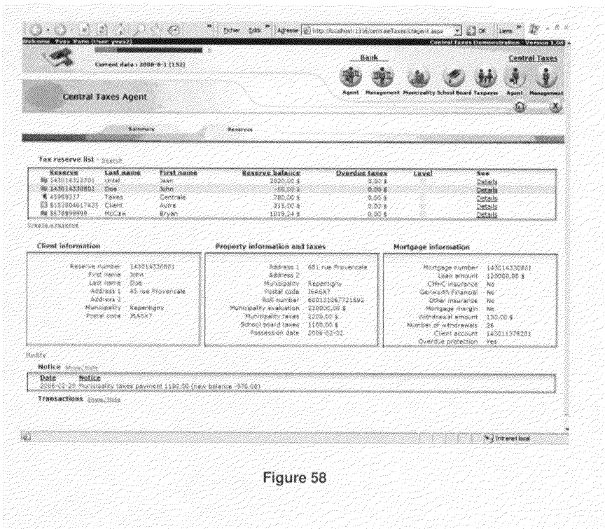

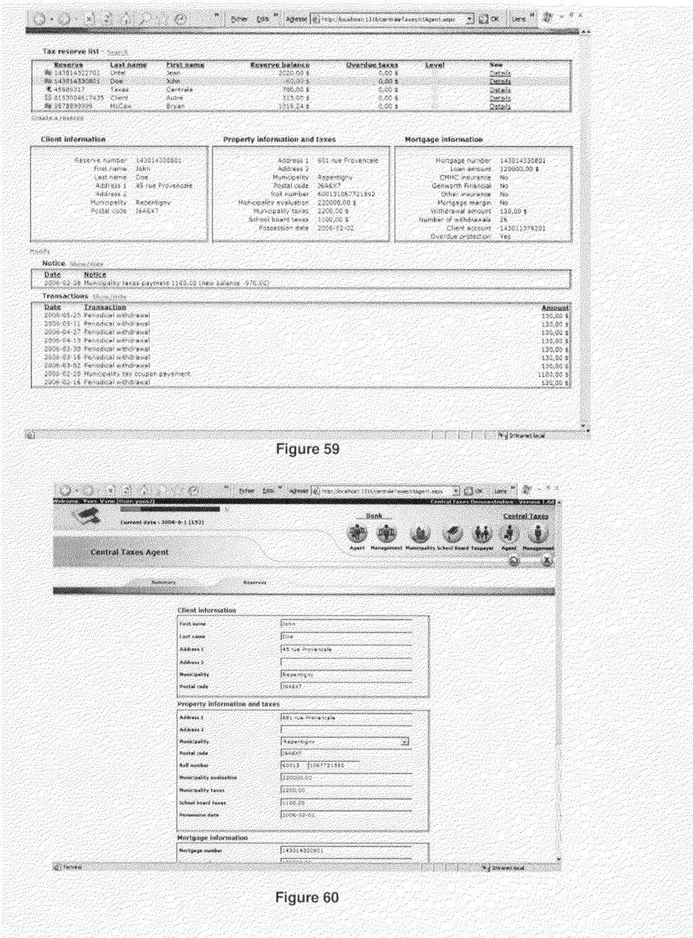

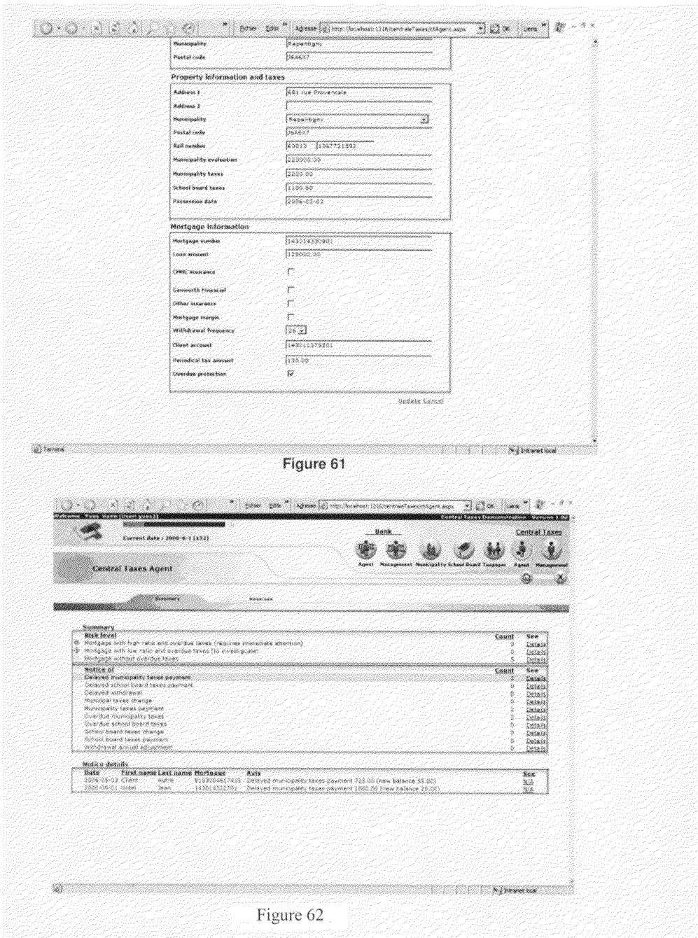

Referring to FIGS. 12 to 68, there are shown screen captures of demonstration software prepared according to a preferred embodiment of the invention. The software highlights the full range of functionalities available through the central system. It will be understood by one skilled in the art that the central system, also called platform, explained below is given for illustrative purposes and that the invention could be embodied by a variety of other systems.

This demonstration highlights the business needs of the potential clients, is an overview of the business according to the present invention and shows a high level feature list of what may be offered through the platform.

This demonstration platform reproduces and simulates operations of the central system according to the invention. The financial institutions, municipalities or school boards are “virtual” in the demonstration and all transactions are done in fictive bank accounts. The demonstration platform simulates all required pre-authorized debits (PAD) and Electronic Funds Transfer (EFT).

The system platform is a broker which facilitates the exchanges between various organizations; its users have access rights (such as user ID and password) that limit their interactions to the specific role they will individually undertake in the production environment. Nonetheless, and for the sake of the present demonstration, the demonstration platform has made all seven (7) roles available in the navigation header.

The system's benefits are apparent only when ran over time; tax coupons are paid once or few times (up to six) per year, withdrawals are executed once a week, every two weeks or once a month and adjustments are made annually.

In order to showcase all those operations, a timeline simulation is introduced. Using the simulation, one can visualize the state of the platform at any key periods within a two year timeframe.

How this simulation works is very simple. It starts on Jan. 1, 2006 and ends on Dec. 31, 2007. At the beginning, for the most part, the bank accounts and tax reserves are set to zero and there are only 4 mortgage clients out of which: two are from the targeted financial institution (ex. National Bank), one is from another institution (ex. Desjardins) and the last is a client from the system directly (tax reserve without mortgages).

The current date and the simulation bar are always found at the top left corner of the screen. One can advance the time period at all time by pressing on the arrow (on the right side of the simulation bar) and is then asked to select the next date to which the timeline should be advanced to. To advance by at least one day shows operations being made.

Although in this embodiment it is not possible to go backward in time, the simulation can be reset to Jan. 1, 2006. This action restores the initial state of the demonstration including all accounts and clients hence erasing all new data inputted during the simulation.

Preferably, each demonstration user account has its own complete simulation environment with its exclusive copy of bank accounts, mortgages and tax reserves. Each account has its internal clock for the simulation hence preserving all data across multiple sessions.

The goal of this simulation is to demonstrate each type of transaction at least once and to present tax reserves at various key periods throughout the year. It has to be understood that another embodiment, used in real life could have different goals, different screens, and different options, as apparent to a person skilled in the art.

The key simulation dates are:

| Simulation Date | Objective |
|---|---|
| January 1^{st} 2006 | Present the initial state of the simulation. |
| March 1^{st} 2006 | Execute the first city of Repentigny tax coupon |
| | (payable February 28^{th} 2006). |
| March 2^{nd} 2006 | Show the payment of an overdue tax coupon |
| | following a deposit in the client's account and show |
| | the issuance of an overdue notice. |
| September 30^{th} 2006 | Show the second payment of city of Repentigny tax |
| | coupon and the coupon for the Affluents school |
| | board. |
| January 1^{st} 2007 | Show the issuing of taxes increase notices at the |
| | beginning of the year. |

### Access to the System

Shown in FIG. 12, there is a screen welcoming a user to the demonstration where the user is invited to log-in. The welcome screen requires user username 46 and password 48. The demonstration embodiment of the software welcomes the user and adapts to its predefined bank, which will be used during the demonstration, for example National Bank.

Please note that a typical user ID and a password will give access to one role only. In the scope of the presentation software, the 7 roles are displayed on the same screen (so that cumbersome log in and log out can be avoided) for convenience sake.

The demonstration embodiment of the software includes, on top of screens, for the various roles of the system, specific screens to change actors (where no specific login is required other than the primary one to go from one role to another) and a tool to manage a virtual timeline. This timeline is used to follow track on the time simulation and therefore the transactions simulation.

As shown in FIG. 13, the demonstration embodiment of the software is composed of three distinct areas:
The first section is “The Header” 40. It includes the generic information (such as logo, user name) and the timeline tool allowing the user to advance in the simulation. The time can be advanced in days, weeks or months and allows the full simulation on internal platform events such as payment orders, notifications, and interest's computation. The simulation date (current date) is always visible with the total balance of the trust. A re-initialization button allows the user to reset the timeline to its starting date. It erases all events from the demonstration and comes back to the initial configuration and parameters.
The second section is “The actor selection” 42. It presents a list of various roles a user can assume upon its assigned UserID and password (the current role is depicted by a highlighted icon):
   mortgage agent;
   bank management;
   mortgage client;
   municipality;
   school boards;
   Central Taxes agent; and
   Central Taxes management.
Although not shown in the present example, the system may also include a screen for mortgage or title insurers who may need to access information similar to the ones provided to mortgage lenders.
The third section is “The main pane” 44. Depending on the role assumed, it displays the corresponding screen with tabulation navigation.

These sections contain the icons 110 representing the 7 roles and connect to the corresponding screens. The date 112 of the simulation is also shown, where the progression bar 114 moves according to the simulation time on a two years period (upright arrow).

### Mortgage Agent (Bank)

The mortgage agent uses a screen that lists all the notices from its own files. The agent can also list all tax reserves linked to its mortgages. Furthermore, the agent can consult the mortgage details with a tax reserve.

During a mortgage creation via the loan origination system (LOS), the agent can send to the central system all the details concerning the tax reserve to be created. The demonstration software then simulates a mortgage request, using a limited number of information. Then, the user has the option to send all the details to the central tax system, the fields presented are preferably:
mortgage selection screen with sortable list/filter per branch (and search option);
mortgage creation screen with button “send to Central Taxes”;
client section:
   branch number/client number/file number;
   client's full name and address;
property section:
   property address (finite number of cities);
   role number upon address and postal code (as well as a validation with city's number);
   annual amount for municipal taxes and school boards;
transaction section:
   mortgage type (loan or line of credit/insured mortgage or not) radio buttons for altering notices;
   mortgage number;
   taking possession date;
   mortgage withdrawal frequency;
   municipal taxes amount;
   school boards amount;
   calculation of a taxation estimate in the case of a brand new construction;
   calculation of real property transfer tax, where applicable;
“Send to Central Taxes” check box (forced if it is a SCHL loan);
confirmation display for the reserve tax methods with:
   city's role number and school board's zone verification;
   display of amounts and payment due dates for municipal withdrawals;
   display of amounts and payment due dates for school boards withdrawals;
   tax adjustment upon taking possession date; and
overdue protection check box in case the reserve balance would be negative;

Preferably, it is not feasible to modify the file data once it has been sent to the central system and only an agent can modify it.

The new tax reserve is now displayed in the list of mortgages and the details can also be displayed.

When the user clicks on the button “Agent” 110 under the heading “Bank”, the system moves to the summary of the transactions 116 of the mortgage agent. It then presents the notice including risk levels 118 (green, yellow and red), in relation with overdue taxes and the loan to value (LTV) ratio where green=no overdue taxes and low LTV, yellow=average LTV ratio and low amount of overdue taxes and blinking red=high LTV ratio and overdue taxes amount.

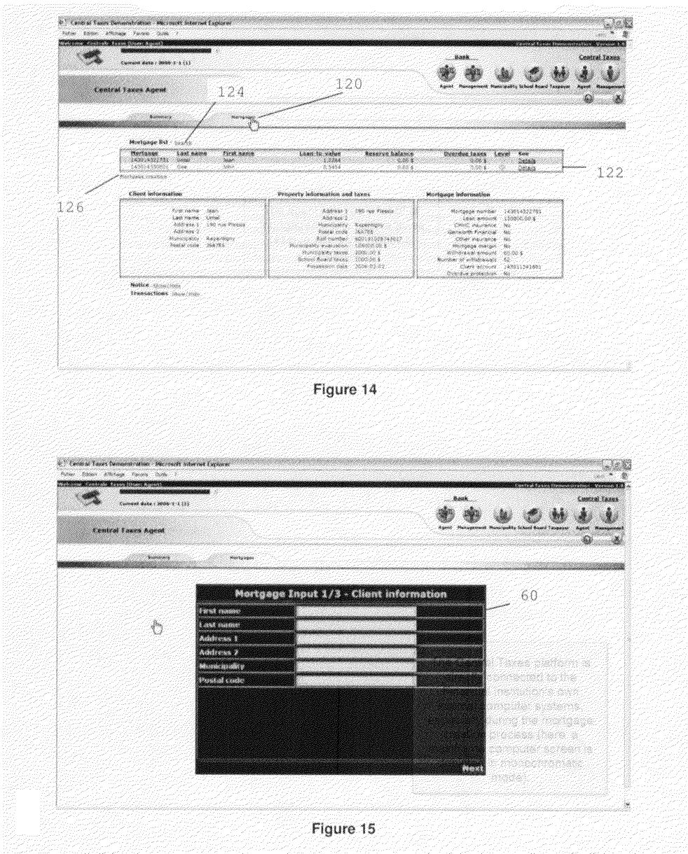

The user then clicks on “Mortgage” 120 and the system moves to the list of mortgages 122 of the financial institution (FIG. 14). A list of customers is presented and the first customer which is selected by default is Jean Untel, having no overdue protection.

It is possible to do a search with a search button 124 provided in the screen of FIG. 14. The search function is especially useful with a large number of mortgages. A sort function is also available and useful with a large number of mortgages.

To create a mortgage, one can click on “Mortgage creation” 126 (FIG. 14). The screen of FIG. 15 appears and a new mortgage can be added. The software preferably accepts mortgage data in bulk or in real time from the bank system. Data is entered in bulk as shown in FIGS. 15 to 17, when different information 60, 62, 64 are needed.

When the mortgage creation is done, the screen illustrated in FIG. 18A is presented showing the initial amount required to fulfill all taxation obligations for the year 128; amount preferably presented by the mortgage agent to the borrower in order to seek and obtain its acceptance. The municipal and school taxes as well as the entry adjustment are then calculated automatically by the software.

FIG. 18B represents a summary of the various property information gathered or calculated by the central system for each property related to a tax reserve account according to one embodiment of the invention. In this example, this page includes basic information on the property such as roll number and civic address, as well as the current assessment, the due dates and instalments for the current year, transfer taxes to be paid, periodic withdrawal to build a tax reserve and tax adjustment based upon taking possession date.

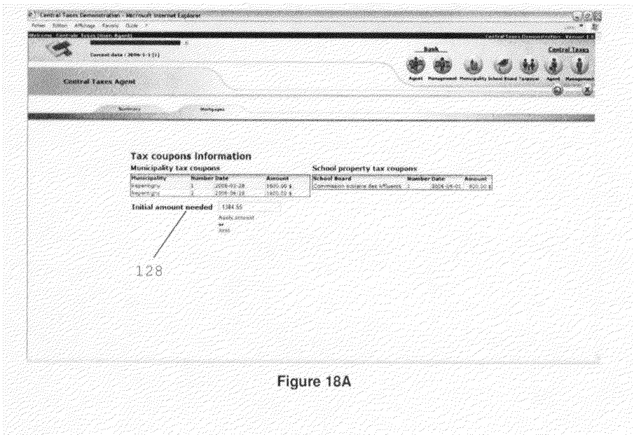

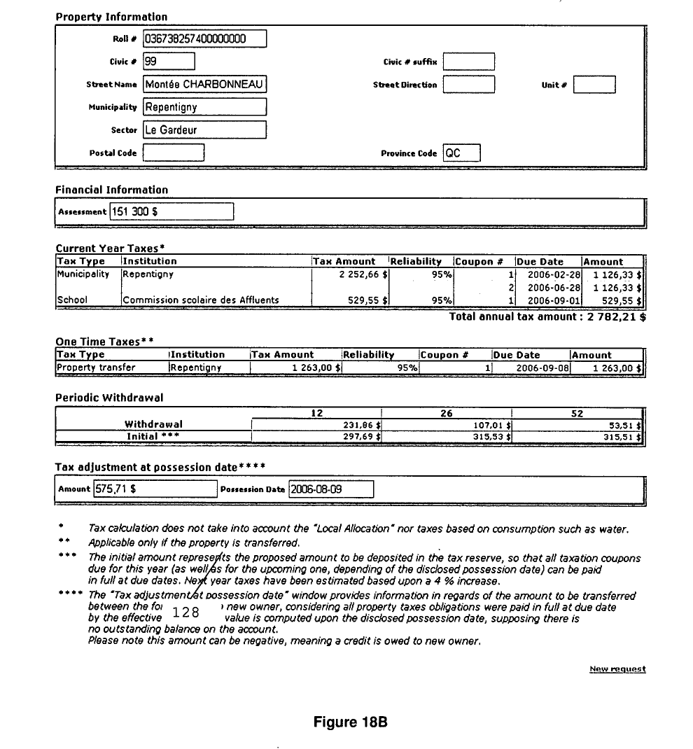

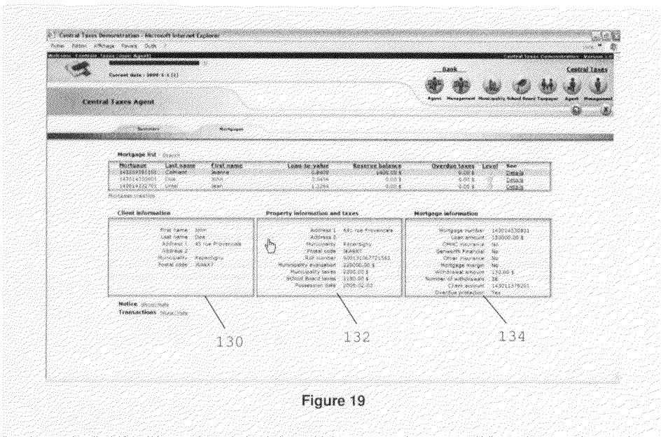

FIG. 19 shows a mortgage list with client 130, property 132 and mortgage 134 information.

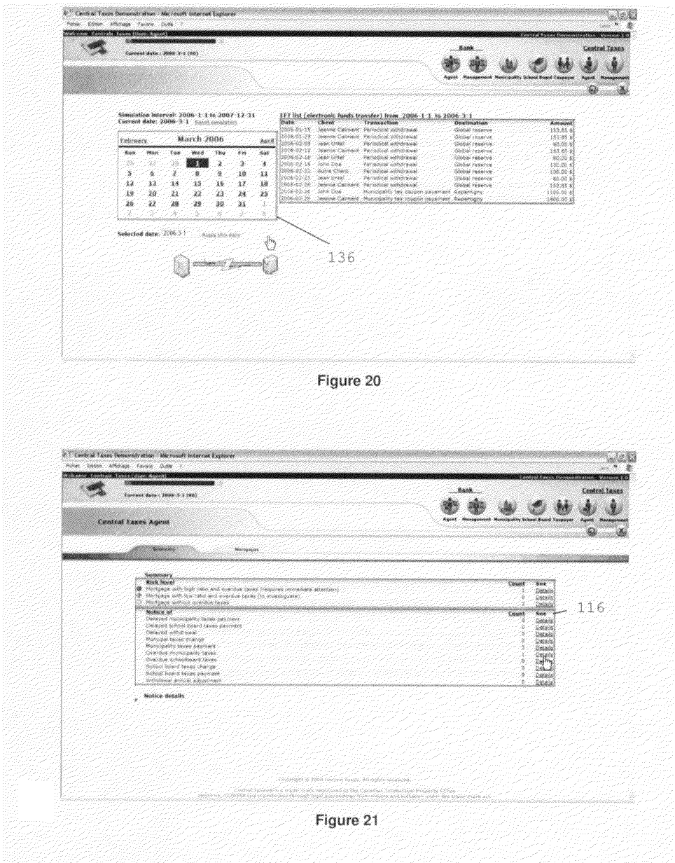

FIG. 20 shows a change in the simulation date and the time bar (on the top left). A user can select a date manually 136 in order to see the summary of the mortgage transactions of the mortgage agent after the selected date.

FIGS. 21 to 24 show that on Mar. 1, 2006, John Untel is in default of payment for a tax coupon of $1000 and has only $180 in the reserve because he has only done three deposit of $60.

A notice letter 138 for overdue municipality taxes for the amount of $1,000,00 is generated and sent to the customer as shown on FIG. 23.

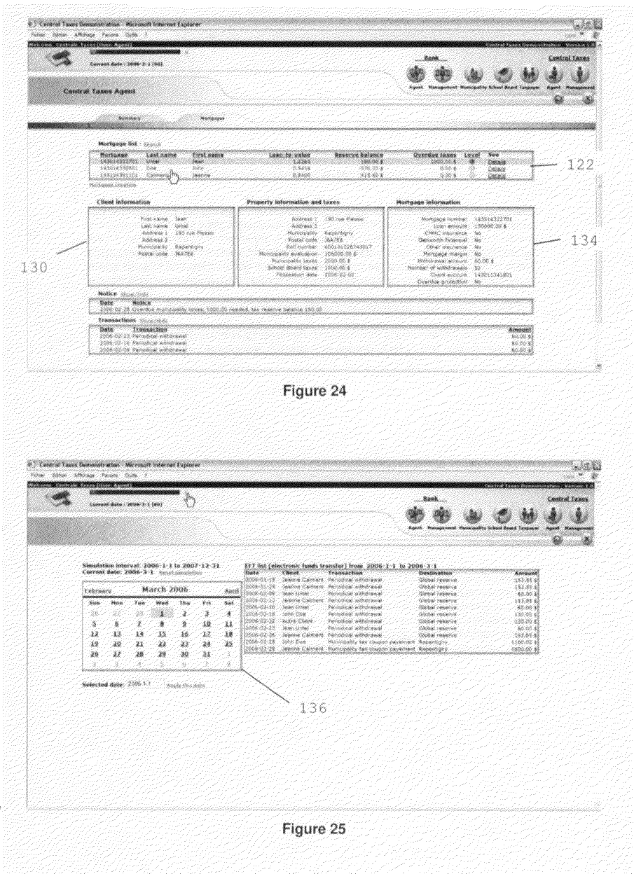

There are shown other operations and simulations of date changes in FIGS. 24 to 32.

FIGS. 33 to 35 show the central system dynamic PDF document generation.

FIG. 30 shows the Municipality and School board annual tax raise notice 139 that is dynamically generated by the system at the beginning of each calendar year. This notice is sent prior to the first coupon payment in the new year and intended namely to advise the taxpayer of the automatic update of its periodical withdrawal amount upon his new tax accounts (municipal and school board) total amount.

### Bank Management

The bank management has its own dashboard to supervise the transactions and operations related to its trust. This screen shows:
total new revenues;
cumulative Net Interest Income (NII);
reserve revenues;
operations;
volumes;
trust's tax reserve balance, including revenues without interests (daily rate);
new revenues (50% of the transactions costs charged to the mortgage's client—SCHL or not);
opportunity cost (cost per transaction unit times number of transactions based on the different transaction types;
gain on fixed and variable costs (cost per transaction unit times number of transactions); and
number of transactions and withdrawals;
   as well as the simulation screen that is off the virtual time line described earlier that allows the user to adjust any parameters independently to visually depict any given reserve scenario. The parameters that can be changed read as follow:
initial balance;
number of clients;
number of withdrawals per year;
annual taxes amount;
reserve interest rate;
overdue interest rate;
transaction fee;
NSF ratio;
saving per transaction; and
opportunity cost per transaction.

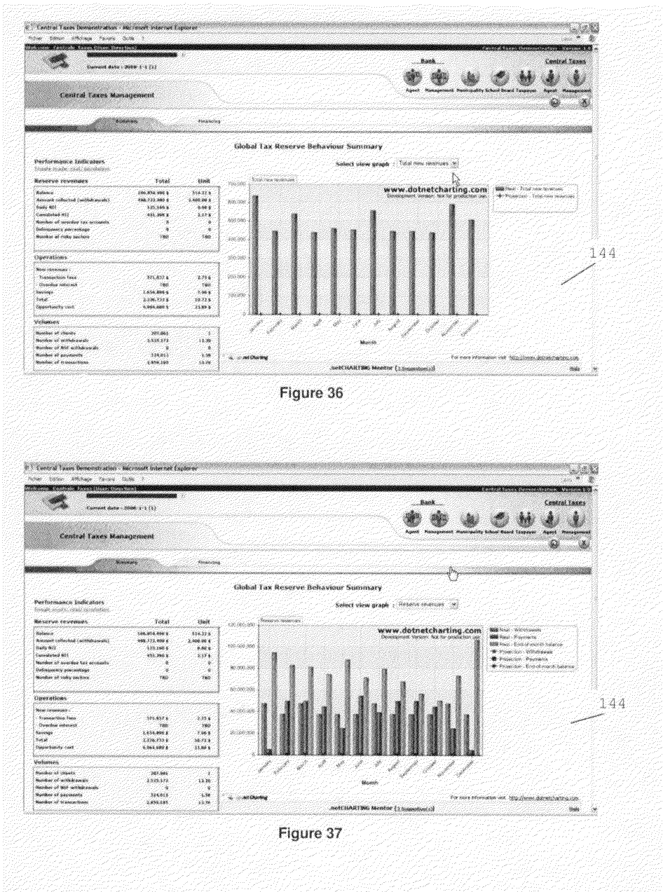

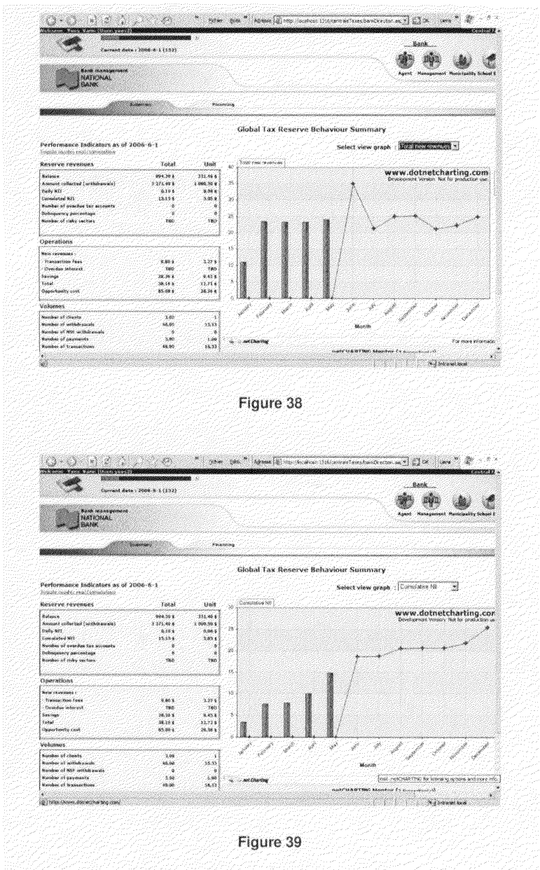

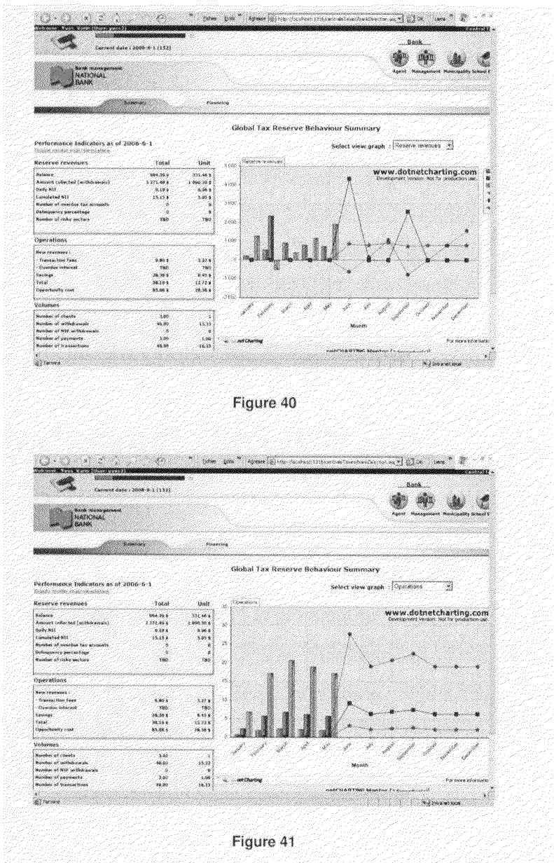

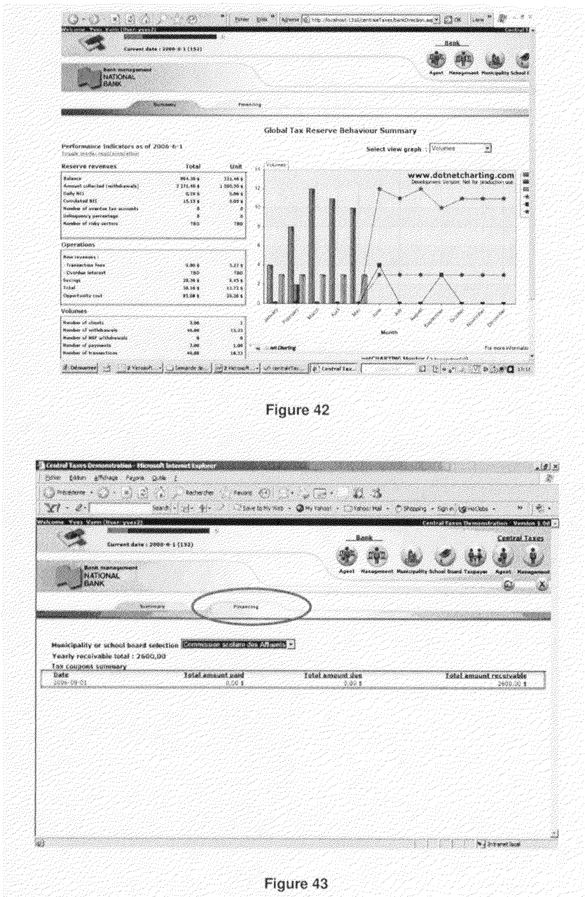

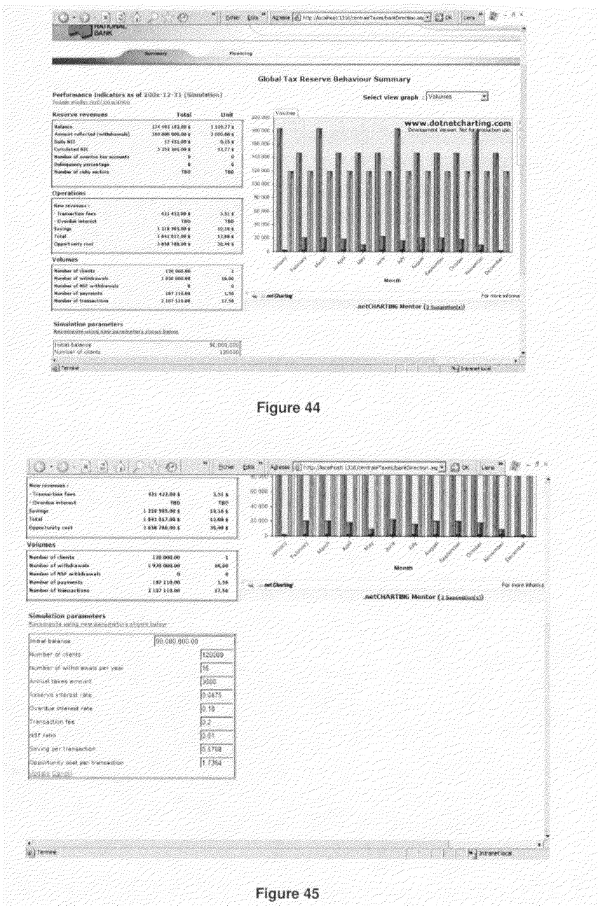

FIGS. 36 to 44 show the central system bank management screens. More particularly, FIGS. 36 and 37 shows a screen accessible to the management of a bank, showing the global tax reserve behaviors summary on Jan. 1, 2006 for total new revenues and reserve revenues, respectively. FIG. 38 shows the same screen as FIG. 36 but on Jun. 1, 2006, where the data for the first five months of the year is real and the data for the remainder of the year is projected upon current portfolio performance. For the same date, FIG. 39 shows the real and projected cumulative NII (Net Interest Income) as well as FIG. 40 shows the reserve revenues, FIG. 41 shows the operations and FIG. 42 shows the volumes. FIG. 43 shows the financing, which is a useful tool for estimating the future payments to be done per municipality (thus allowing possible “ahead of time” fund transfers between financial institutions and identified creditors), FIG. 44 is a simulation screen (off the virtual time line), for making projections under various selected scenarios and FIG. 45 shows a parameters selection entry screen.

### Municipalities/School Boards

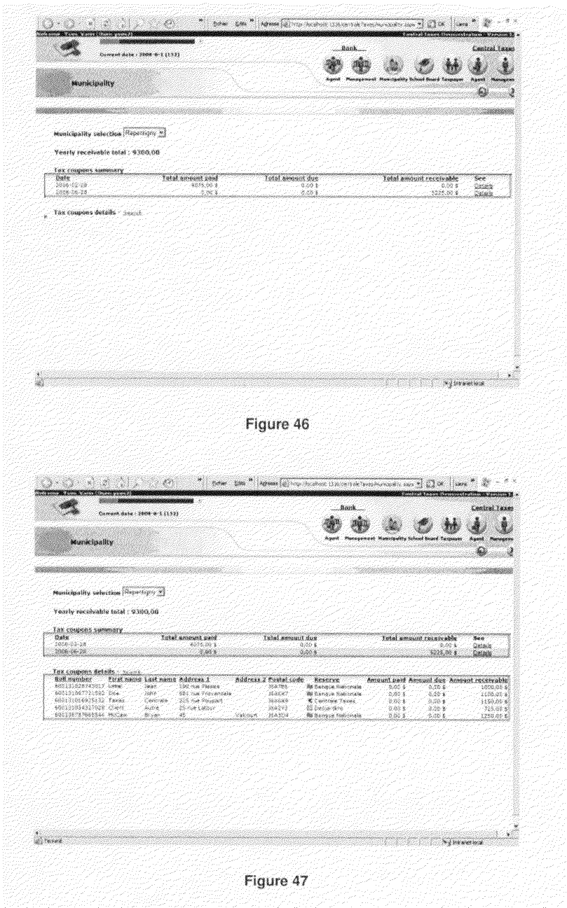

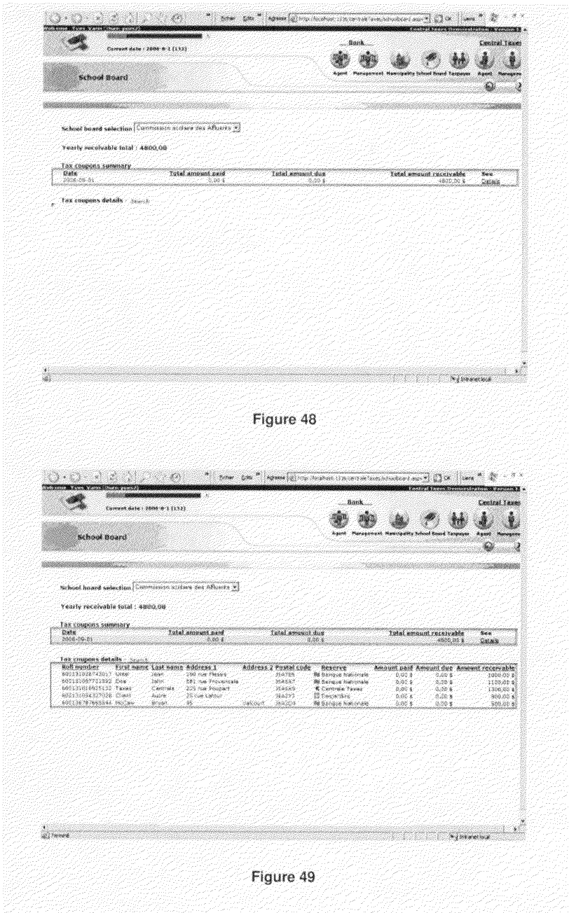

FIGS. 46 to 49 show the central system municipalities and school board screens. More particularly, FIG. 46 shows the municipalities, FIG. 47 shows more details, FIG. 48 shows school boards and FIG. 49 shows more details.

Clicking on the button “Management” moves to the dashboard 144 of the bank management and presents the performance indicator and the simulation of the reserve for the remainder of the year.

The municipalities and school boards have the same screens on their own data. They are screen for transaction summaries and notices, including a list of summary messages (sorted in chronological order). Examples: “date—tax payment of n$ for client x” or “date—tax change for client x”.

Each summary line (when selected) brings the user to the details of the transactions or information. This page includes a list with sorting options on columns.

Clicking on the “Municipality” button shows the summary of the tax coupons by municipality and presents the amounts projected by the software and payable coupons by customers.

### Mortgage Client

FIGS. 50 to 55 show the central system taxpayer screens and show a statement of account 140 accessed by clicking on the button “Taxpayer” and later on “See Statement of Account” hyperlink. This statement of account is preferably incorporated into a transactional web page of a bank 142, as shown in FIG. 53. The central system provides dynamic content to the web page of the bank, which uses it into its own interface.

The mortgage clients access their own file to consult:
their reserve balance;
their transaction list; and
the list of notification with detailed viewing.

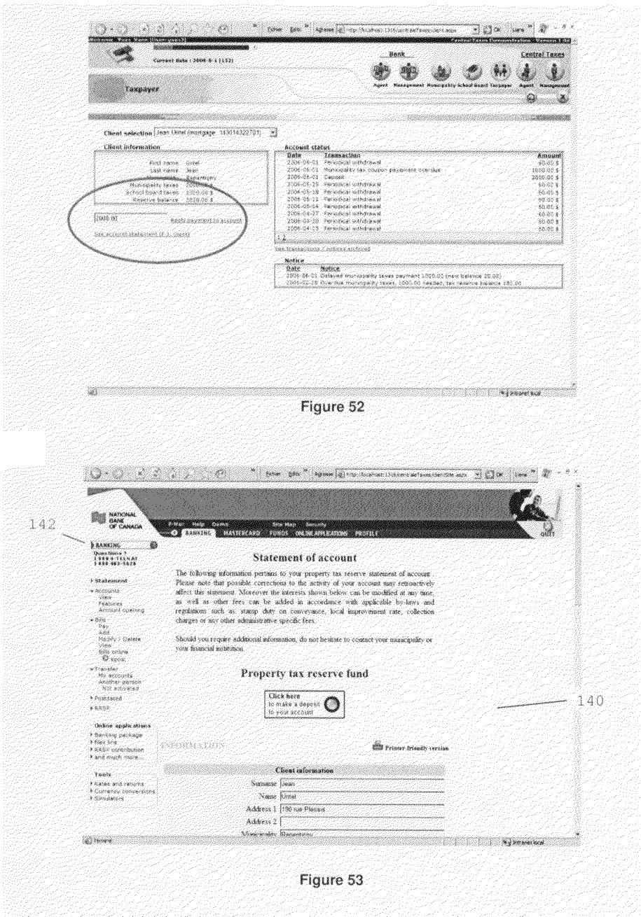

Mortgage clients can also interact with the system. For example, as shown in FIG. 52, clients can transfer funds to their tax reserve from their banking account by simply inscribing the desired amount in the appropriate box and clicking on “Apply payment to account”

### Central System Agent

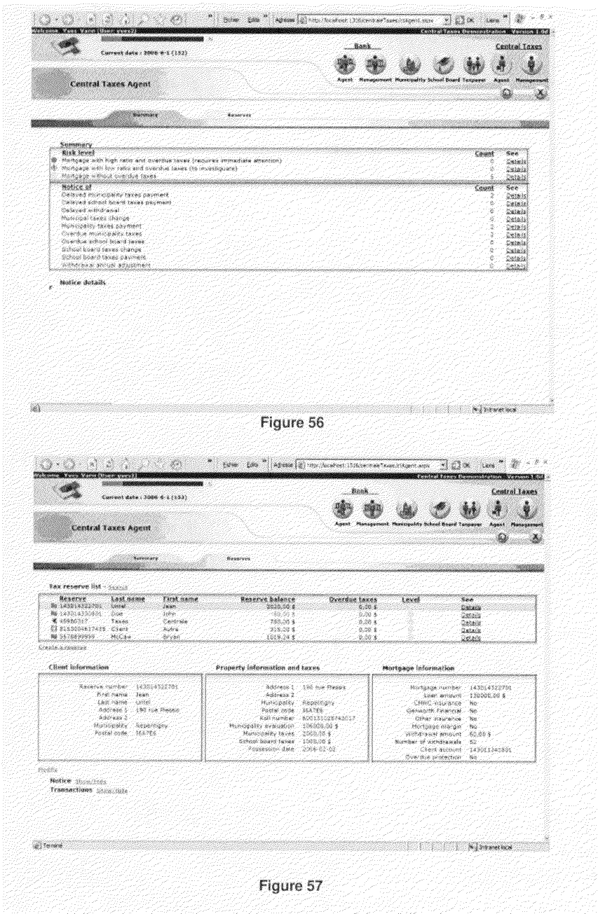

FIGS. 56 to 62 show the central system Agent & Management screens.

The Central Taxes Agent's task is to sort through and act on the various notices and to notify/create and follow up on tax reserves.

The initial screen displays all the notices for the agent with sorting and filters on status. A notification can have one of the following statuses: not read, read, in progress, sent, alerts, closed. These status changes are controlled by the agent.

The second screen lists the tax reserves and their modifications. It also:
lists all tax reserves (sorting and search functions—per name/role/city/zip);
modify a file with access to its history of events (notifications, modifications, payments);
edit a file (most fields are editable); and
create a new tax reserve (the screens are similar to the ones from the mortgage agent but with the central tax management system's skin).

### Central System Management

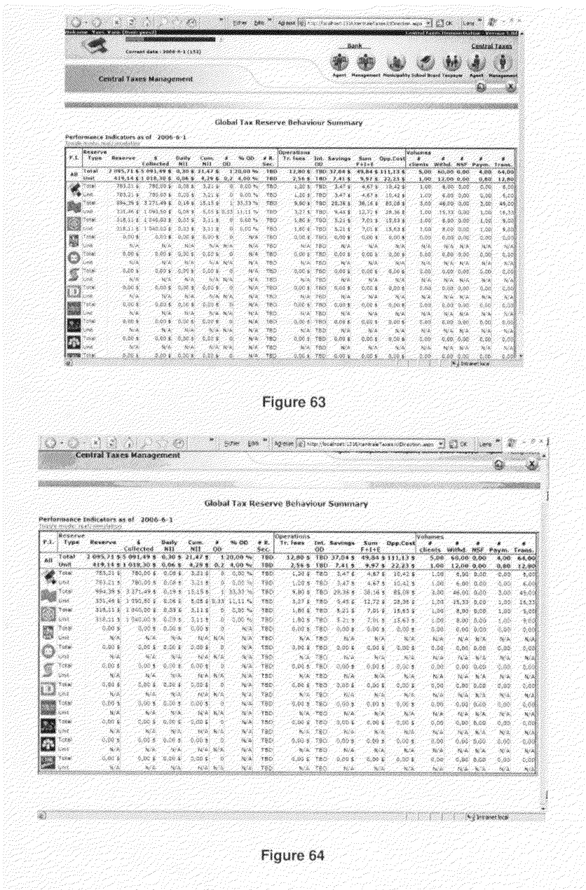

FIGS. 63 to 66 show the Central Taxes management screens.

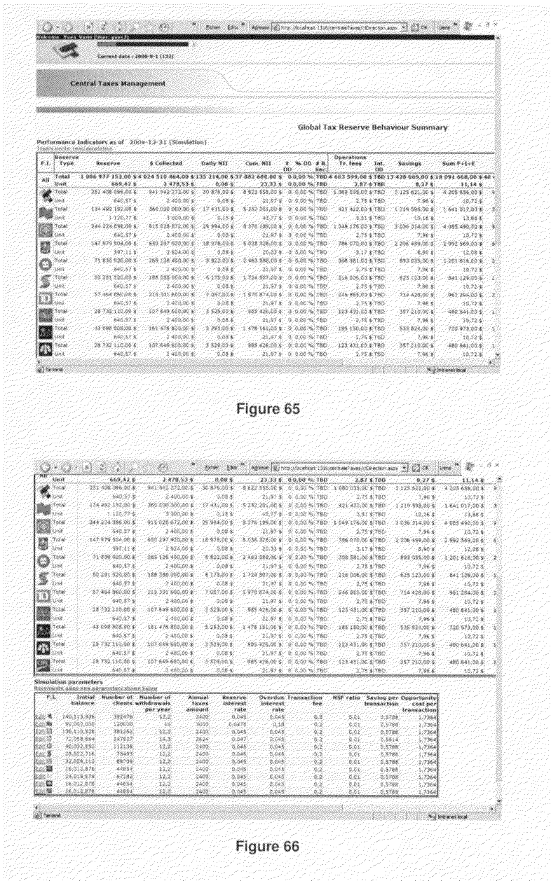

The central system management has its own dashboard, for the system wide monitoring of operations on the platform. In the current example, a Global Tax Reserve Behaviour Summary is given, broken down for each client financial institution, as well as for its own trust (Central Taxes). This trust provides accounts intended for “orphan” taxpayers i.e. not affiliated with a bank or having already paid its mortgage and wanting to benefit from the advantages of a tax reserve. The central system management dashboard includes elements such as access to bank dashboards (balance+interests+transactions, etc) and is separated into three areas, respectively for tax reserves, operations and volumes. A toggle mode link allows switching between real data (FIGS. 63 and 64) and simulated data (FIGS. 65 and 66). As shown in FIG. 66, in the simulation mode, the simulation parameters are presented at the bottom of the screen and can be edited.

The central system can also preferably manage the user accounts (name, passwords and financial institution).

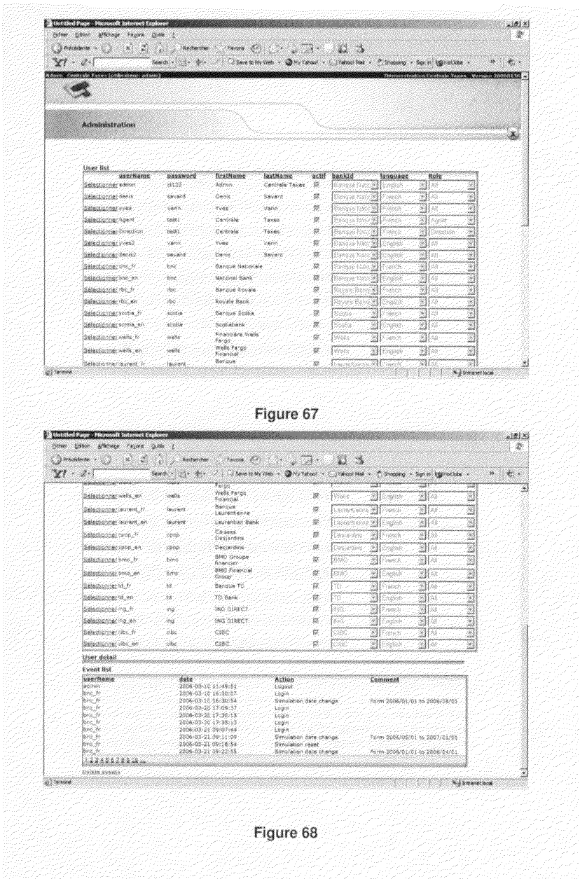

FIGS. 67 and 68 show the central system administration screens, where FIG. 68 shows an event list.

### Reference Parameters and Initialization

The mortgage agent sends to the central system all the information for the tax reserves. The reference parameters are included in the database without screen capture. They are:
administrator account;
city code, dates and withdrawals schedules; and
miscellaneous.

In the demonstration embodiment of the software, when a new account is created or when the timeline has been reset by a user, the default data (all five accounts and associated events) is regenerated.

The predefined accounts of this embodiment of the invention used are representative to allow generation of pertinent events on precise schedules, for example, when tax amounts changes with a new year.

### Parameters

A parameter screen is available for the administration, to update the daily interest rate and the unit transaction costs used in the dashboard computations. In simulation mode, this screen allows changes to be made to the following parameters:
initial balance;
number of clients;
number of withdrawals per year;
annual taxes amount;
reserve interest rate;
overdue interest rate;
transaction fee;
NSF ratio;
saving per transaction; and
opportunity cost per transaction.

### Administration & Monitoring

The Administration and Monitoring screen, for demonstration accounts, allows the creation of the user accounts and passwords to access the various financial institutions panorama and take into account all transactions and events on the system with the help of a listing. In this embodiment of the invention, the PDF documents are dynamic; notices are presented as a template associated with the personalized HTML page.

According to this embodiment of the preferred invention, the software is realized with the Microsoft development tools and uses the latest ASP Microsoft technologies and .NET, as well as the SQL data base Server.

### Architecture

The preferred embodiment of the central system preferably consists of a data base (SQL server), of ASPX pages and C # code (C sharp), running under the framework .Net 2.0 of Microsoft.

### Data Model

The data model for the database, preferably consists of three types of tables:
the reference data which do not change and are used to identify banks, municipalities, etc.;
the system data which allow to manage the users and their events; and
the user data of the simulation.

### Reference Data

Examples of tables for municipalities and school board are given hereafter.

LANGUAGE TABLE

| Field | Type | Comment |
|---|---|---|
| id | Int | Unique entry |
| name | Char 20 | Language name |

NOTICETYPE TABLE

| Field | Type | Comment |
|---|---|---|
| id | Int | Unique entry |
| langage | Int | Used language |
| type | Char 120 | Notice text |

EVENTTYPE TABLE

| Field | Type | Comment |
|---|---|---|
| id | Int | Unique entry |
| text | Char 50 | Event text (English only) |

BANK TABLE

| Field | Type | Comment |
|---|---|---|
| id | Int | Unique entry |
| name | Char 20 | Language name |
| otherBank | Int | Number of the other bank for the |
| | | mortgage “other” created by |
| | | default for the simulation |

MUNICIPALITY TABLE

| Field | Type | Comment |
|---|---|---|
| id | Int | Unique entry, equal to the municipal |
| | | code (5 numbers) used in the serial |
| | | number |
| name | char 30 | City name |
| commisionId | Int | School board entry (link n<->1 for |
| | | the demo) |

SCHOOLBOARD TABLE

| Field | Type | Comment |
|---|---|---|
| id | Int | Unique entry automatically generated |
| name | Char 30 | Name of the School board |

MUNICIPALITYTAXFREQUENCY TABLE

| Field | Type | Comment |
|---|---|---|
| municipalityId | Int | Municipality entry |
| date | Date | Day and month of the withdrawal |
| coefficient | Float | Coefficient (<=1) |

SCHOOLBOARDTAXFREQUENCY TABLE

| Field | Type | Comment |
|---|---|---|
| municipalityId | Int | School board entry |
| date | Date | Day and month of the withdrawal |
| coefficient | Float | Coefficient (<=1) |

TRANSACTIONTYPE TABLE

| Field | Type | Comment |
|---|---|---|
| id | Int | Type of transaction entry |
| language | Int | Used language |
| text | Char 50 | Transaction text |

Preferably, for both tables: municipalityTaxFrequency and schoolBoardTaxFrequency, the sum of the coefficients should be equal to 1.

### System Data

USERS TABLE

| Field | Type | Comment |
|---|---|---|
| id | Int | Unique entry |
| userName | Char 12 | User name |
| password | Char 12 | Password |
| firstName | Char 30 | |
| lastName | Char 30 | |
| email | Char 50 | |
| admin | Boolean | True if administrator |
| actif | Boolean | Default true, can be override by the |
| | | administrator |
| roleId | Int | Role type (all/agent/direction) |
| bankId | Int | Link to bank table |
| languageId | Int | 0 English |
| | | 1 French |

EVENT TABLE

| Field | Type | Comment |
|---|---|---|
| userId | Int | User origin the event |
| date | Date | Event date |
| type | Int | Event type (login, logout . . . ) |
| sourceId | Int | Idem userID! |
| text | Char 80 | Text of comment (example interval |
| | | dates for change of date) |

LANGUAGE TABLE

| Field | Type | Comment |
|---|---|---|
| id | int | Parameter name |
| name | Char 20 | Language name |

### User Data Demo

TABLE MORTGAGE

| Field | Type | Comment |
|---|---|---|
| id | Int | Unique entry self generated used as |
| | | file number |
| userId | Int | Data owner |
| bankId | Int | Mortgage bank |
| bankBranch | Int | |
| clientFirstName | char 30 | |
| clientLastName | char 30 | |
| clientAddress1 | char 60 | |
| clientAddress2 | char 60 | |
| clientMunicipality | char 60 | |
| clientPostalCode | char 6 | |
| propertyAddress1 | char 60 | |
| propertyAddress2 | char 60 | |
| propertyMunicipality | char 60 | |
| propertyPostalCode | char 6 | |
| propertyRoleNumber | int | |
| propertyMunicipalityTax | money | Annual amount of municipal taxes |
| propertySchoolBoardTax | money | Annual amount of school board taxes |
| mortgageNumber | int | |
| mortgageSCHL | boolean | |
| mortgageOtherInsurance | boolean | |
| mortgageMargin | boolean | Mortgage margin |
| mortgageFrequency | int | 12/24/26/52 |
| mortgageStartDate | date | |
| mortgageTotalAmount | money | |
| mortgagePeriodicAmount | money | |
| clientAccountNumber | int | |
| microLoan | int | |
| taxReserveAccountId | Int | Account of the tax reserve |
| clientAccountId | Int | Customer account |

TABLE ACCOUNT

| Field | Type | Comment |
|---|---|---|
| id | int | Unique entry self generated |
| userId | int | Data owner |
| AccountType | int | 0 - Reserve |
| | | 1 - Municipality |
| | | 2 - School board |
| | | 4 - Customer |
| ownerId | int | Number of the authority in the |
| | | associated type |
| parentId | | Account of the main trust |
| balance | money | Account balance |

NOTICE TABLE

| Field | Type | Comment |
|---|---|---|
| id | int | Unique entry self generated |
| userId | int | Data owner |
| mortgageId | int | Mortgage entry |
| date | date | Notice date |
| type | int | 0 - Delay of withdrawal |
| | | 1 - late payment |
| | | 2 - tax amount change |
| amount1 | money | Amount use for text |
| amount2 | money | Amount use for text |

TABLE TRANSACTION

| Field | Type | Comment |
|---|---|---|
| id | int | Unique entry |
| userId | int | Data owner |
| date | date | Date + Time of transaction |
| type | int | Type of transaction (interest, |
| | | payment, withdrawal) |
| outAccountId | int | Debit account |
| inAccountId | int | Credited account |
| taxReserveId | int | Reserve number |
| amount | money | Transaction amount |
| municipalityOrScoolId | int | City or School board number |
| | | concerned by the transaction |

MUNICIPALITYCOUPON TABLE

| Field | Type | Comment |
|---|---|---|
| id | int | Unique entry |
| userId | int | Data owner |
| municipalityId | int | City entry |
| mortgageId | int | Mortgage entry |
| date | date | Date + time of transaction |
| number | int | Coupon number |
| status | int | Status (owe, late, paid) |
| amountToPay | money | Amount to pay |
| amountPaid | money | Amount paid |
| amountOverDue | money | Late amount |
| transactionId | int | Transaction number |

SCHOOLBOARDCOUPON TABLE

| Field | Type | Comment |
|---|---|---|
| id | int | Unique entry |
| userId | int | Data owner |
| schoolBoardId | int | Municipality entry |
| mortgageId | int | Mortgage entry |
| number | int | Coupon number |
| status | int | Status (owe, late, paid) |
| date | date | Date + time of transaction |
| amountToPay | money | Amount to pay |
| amountPaid | money | Amount paid |
| amountOverDue | money | Late amount |
| transactionId | int | Transaction number |

In this embodiment of the invention, the application code is preferably split in three sections:
the source code of the demonstrator;
the HTML code pages; and
the HTML support code pages.

According to yet another preferred embodiment, the software preferably includes the following functionalities:
for the central tax management system:
   secured database;
   tracking of secured electronic banking transactions;
   transaction reporting console;
for the financial institution:
   simulation of a mortgage loan creation process with the “Send to Central Taxes” button;
   transaction reporting console;
   relevant alerts;
for the municipalities:
   transaction reporting console;
adding a new mortgage client to the system (personalized by Bank/Credit Union);
taxes coupon payment order:
   to the municipality;
   to the school board;
taxes coupon payment notice:
   to the financial institution;
   to the mortgage client;
   to the municipality;
   to the school board;
overdue taxes payment notice (for municipal or school board taxes):
   to the financial institution;
   to the mortgage client;
for the financial institution, illustrations (charts) and numeric indicators:
   taxes reserve balance (in trust);
   net interest income (NII);
   opportunity cost;
   new revenues;
   savings;
   number of transactions/clients;
for the finance department, taxes account listings:
   to the municipality;
   to the school board;
console display for all system functions monitoring;
withdrawal annual adjustment notice:
   personalized letter (bank letterhead) sent to client;
periodical withdrawal notice (conventional or insured mortgage):
   personalized letter (bank letterhead) sent to client;
periodical withdrawal notice (Mortgage margin):
   personalized letter (bank letterhead) sent to client;
for the client:
   taxes reserve statement of account;
   taxes raise notice;
   current balance (for online consultation);
online taxes reserve creation (by the client):
   for Central Taxes;
   for a financial institution (within the bank's transactional web site bearing its own livery and its Web site look);
electronic batch loading;
integration DLL or Web service schemas for the financial institution loan origination system (LOS);
integration DLL or Web service schemas for the financial institution loan management system (LMS), banking system and current taxes reserve system, if any;
integration DLL or Web service schemas for the financial institution taxes reserve trust;
actual online taxes reserve creation (by the client);
electronic batch loading of taxes role;
integration DLL or Web service schemas for other taxation systems (In house, PG Mensys, Govern, Nexxlink or the alike); and
online taxes reserve creation (by the client) on the Web site for:
   the municipality; and
   the school board.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A central system for the management of property-related taxes for a plurality of properties, each of said property-related taxes being payable to one of a plurality of taxation authorities each having an electronically accessible information system, taxes for each of said properties being paid by at least one of a plurality of paying entities each having an electronically accessible information system, said central system comprising:
a taxation authorities module in electronic communication with the information system of each of said taxation authorities for retrieving information relative to due dates and instalments of said taxes therefrom;
a processing module for producing tax-related data based on said information; and
a paying entities module in electronic communication with the information system of each of said paying entities for providing said tax-related data thereto.

2. The central system according to claim 1, further comprising a database for storing said tax-related data.

3. The central system according to claim 1, wherein said taxation authorities module further comprises a requests module for sending requests to said information systems of said taxation authorities to obtain said information relative to due dates and instalments therefrom.

4. The central system according to claim 1, wherein said information relative to due dates and instalments of said taxes comprises property assessments of said properties.

5. The central system according to claim 3, wherein said taxation authorities module comprises a translator for converting the requests into at least one taxation authorities format, each of the at least one taxation authorities format being readable by the information system of at least one of the taxation authorities, and for converting the information relative to due dates and instalments received from said information systems from the corresponding taxation authorities format into a central system format readable by the central system.

6. The central system according to claim 1, further comprising the information system of at least one of said taxation authorities and wherein said information system of at least one of said taxation authorities contains said information relative to due dates and instalments.

7. The central system according to claim 1, wherein said tax-related data produced by the processing module comprises, for at least one of said properties, at least one of the due dates, the instalments, an annual taxes adjustment, a total amount of unpaid taxes for a predetermined time period, a total amount of paid taxes for a predetermined time period, and an amount of taxes over due.

8. The central system according to claim 1, wherein said tax-related data comprises tax reserve statements, the processing module comprising a tax reserve statements generating module for generating said tax reserve statements.

9. The central system according to claim 1, wherein said tax-related data comprises statements of account for said properties, the processing module comprising a statements of account generating module for generating said statements of account.

10. The central system according to claim 1, wherein said tax-related data comprises conformity certificates for said properties, the processing module comprising a conformity certificates generating module for generating said conformity certificates.

11. The central system according to claim 1, wherein said tax-related data comprises notices of approaching deadlines for payment of taxes for said properties, the processing module comprising a notices of approaching deadlines for payment of taxes generating module for generating said notices of approaching deadlines for payment of taxes.

12. The central system according to claim 1, wherein said tax-related data comprises notices of non payments of taxes for said properties, the processing module comprising a notice of non payments of taxes generating module for generating said notices of non payment of taxes.

13. The central system according to claim 1, wherein said tax-related data comprises estimates of taxes for said properties, the processing module comprising an estimate of taxes generating module for generating said estimates of taxes.

14. The central system according to claim 1, wherein said tax-related data comprises annual tax reserves adjustments for said properties, the processing module comprising a tax reserves adjustments generating module for generating said annual tax reserves adjustments.

15. The central system according to claim 1, wherein said paying entities module further comprises a requests module for receiving requests from said information system of said paying entities and for sending said tax-related data to said paying entities.

16. The central system according to claim 1, wherein said paying entities module further comprises a translator, for converting the requests into a central system format readable by the central system, and for converting the tax-related data into at least one paying entities format, each of the at least one paying entities format being readable by the information system of at least one of the paying entities.

17. The central system according to claim 1, wherein said central system comprises a user interface accessible via a network.

18. The central system according to claim 17, wherein said user interface comprises screens having links with the processing module of said central system.

19. The central system according to claim 17, wherein the user interface further comprises a security module for verifying a username and a password entered by the user, said username and password being associated with a profile limiting the access of the user to selected of said screens.

20. A method for the management of property-related taxes for a plurality of properties, using a central system, each of said property-related taxes being payable to one of a plurality of taxation authorities each having an electronically accessible information system, taxes for each of said properties being paid by at least one of a plurality of paying entities each having an electronically accessible information system, said method comprising the steps of:
a) retrieving information relative to due dates and instalments of said taxes from the taxation authorities, said central system comprising a taxation authorities module in electronic communication with the information system of each of said taxation authorities therefor;
b) producing tax-related data based on said information, said central system comprising a processing module therefor; and
c) providing said tax-related data to the paying entities, said central system comprising a paying entities module in electronic communication with the information system of each of said paying entities therefor.

21. The method according to claim 20, wherein the central system further comprises a database for storing said tax-related data.

22. The method according to claim 20, wherein step a) comprises retrieving information on property assessments from the taxation authorities.

23. The method according to claim 20, further comprising the step of sending requests to said information systems of said taxation authorities to obtain said information relative to due dates and instalments therefrom, said taxation authorities module comprising a requests module therefor.

24. The method according to claim 23, further comprising the steps of converting the requests into at least one taxation authorities format, each of the at least one taxation authorities format being readable by the information system of at least one of the taxation authorities, and of converting the information relative to the due dates and instalments received from said information systems from the corresponding taxation authorities format into a central system format readable by the central system, said taxation authorities module comprising a translator therefor.

25. The method according to claim 20, wherein the central system further comprises the information system of at least one of said taxation authorities and wherein said information system of at least one of said taxation authorities contains said information relative to due dates and instalments.

26. The method according to claim 20, wherein said tax-related data produced by the processing module comprises, for at least one of said properties, at least one of due dates, the instalments, an annual taxes adjustment, a total amount of unpaid taxes for a predetermined time period, a total amount of paid taxes for a predetermined time period, and an amount of taxes over due.

27. The method according to claim 20, further comprising the step of generating tax reserve statements, wherein said tax-related data comprises said tax reserve statements, and wherein the processing module comprises a tax reserve statements generating module therefor.

28. The method according to according to claim 20, further comprising the step of generating statements of account, wherein said tax-related data comprises said statements of account for said properties, and wherein the processing module comprises a statements of account generating module therefor.

29. The method according to claim 20, further comprising the step of generating conformity certificates, wherein said tax-related data comprises said conformity certificates for said properties, and wherein the processing module comprises a conformity certificates generating module therefor.

30. The method according to claim 20, further comprising the step of generating notices of approaching deadlines for payment of taxes, wherein said tax-related data comprises said notices of approaching deadlines for payment of taxes for said properties, and wherein the processing module comprises a notices of approaching deadlines for payment of taxes generating module therefor.

31. The method according to claim 20, further comprising the step of generating notices of non payment of taxes for said properties, wherein tax-related data comprises said notices of non payments of taxes for said properties, and wherein the processing module comprises a notice of non payment of taxes generating module therefor.

32. The method according to claim 20, further comprising the step of generating estimates of taxes, wherein said tax-related data comprises said estimates of taxes for said properties, and wherein the processing module comprises an estimates of taxes generating module therefor.

33. The method according to claim 20, further comprising the step of generating notices of annual tax reserve adjustment, wherein said tax-related data comprises said notices of annual tax reserve adjustment for said properties, and wherein the processing module comprises a tax reserve adjustment generating module therefor.

34. The method according to claim 20, further comprising the steps of receiving requests from said information system of said paying entities and of sending said tax-related data to said paying entities, and wherein said paying entities module further comprises a requests module therefor.

35. The method according to claim 34, further comprising the steps of converting the requests into a central system format readable by the central system, and of converting the tax-related data into at least one paying entities format, wherein said paying entities module further comprises a translator therefor, for each of the at least one paying entities format being readable by the information system of at least one of the paying entities.

36. The method according to claim 20, wherein the central system further comprises a user interface accessible via a network.

37. The method according to claim 36, wherein said user interface comprises screens having links with the processing module of said central system.

38. The method according to claim 36, wherein the user interface further comprises a security module for verifying a username and a password entered by the user, said username and password being associated with a profile limiting the access of the user to selected of said screens.

39. A method for the automated estimation of taxes payable for a property of interest, using a central system for the management of property-related taxes for a plurality of properties, each of said property-related taxes being payable to one of a plurality of taxation authorities each having an electronically accessible information system, taxes for each of said properties being paid by at least one of a plurality of paying entities each having an electronically accessible information system, said method comprising the steps of:
a) retrieving information on the taxes payable for said property of interest from at least one corresponding one of said taxation authorities, said central system comprising a taxation authorities module in electronic communication with the information system of each of said taxation authorities therefor;
b) producing estimation based on said information, said central system comprising a processing module therefor; and
c) reporting said estimation.
